(19) United States
(12) Patent Application Publication
(10) Pub. No.: US 2024/0126981 A1
(43) Pub. Date: Apr. 18, 2024

(54) SYSTEMS AND METHODS FOR MACHINE-LEARNING-BASED PRESENTATION GENERATION AND INTERPRETABLE ORGANIZATION OF PRESENTATION LIBRARY

(71) Applicant: Armkor, LLC, Austin, TX (US)

(72) Inventors: Mihran Shahinian, Austin, TX (US); James P. Roberts, Austin, TX (US)

(21) Appl. No.: 18/380,633

(22) Filed: Oct. 16, 2023

Related U.S. Application Data
(60) Provisional application No. 63/416,159, filed on Oct. 14, 2022.

(51) Int. Cl. G06F 40/166; G06F 40/30; G06F 40/40; G06N 3/0455; G06V 30/413

(52) U.S. Cl. CPC G06F 40/166; G06F 40/30; G06F 40/40; G06N 3/0455; G06V 30/413

(57) ABSTRACT

Systems, methods, and software applications for using machine learning to auto-generate presentations, slides, and answers are described in the present disclosure. According to one embodiment, among many, an artificial intelligence assistant computing facility is configured to perform machine learning and store instructions that are executable by a processing device to enable a user to create a new slide presentation, find relevant slides, discover related content, generate answers to questions from existing slides, accept text and image suggestions to personalize slides, and view assembled slides and presentations. The artificial intelligence assistant computing facility comprises logic adapted to perform an ensemble of machine learning models to work in tandem for classifying, editing, and generating content. The artificial intelligence assistant computing facility includes logic adapted to process and classify content, determine the similarity of each slide, suggest slides for inclusion in a presentation, and offer recommendations for editing the content. The artificial intelligence assistant computing facility also includes logic adapted to answer questions posed by a user.

### CROSS-REFERENCE TO RELATED APPLICATION

The present application claims priority to U.S. Provisional Application Ser. No. 63/416,159, filed Oct. 14, 2022, the disclosure of which is expressly incorporated herein by reference.

### BACKGROUND AND SUMMARY OF THE INVENTION

The present disclosure generally relates to applying machine learning to presentation software applications for extracting content from slides, finding relevant content, recommending text and image suggestions, and automatically generating answers, slides, and presentations. More particularly, the embodiments described herein relate to systems and methods for recommending slide content and auto-generating answers, slides, and presentations using neural nets, natural language processing, natural language generation, machine learning, and generative artificial intelligence (AI) technology.

Presentation software, such as PowerPoint® from Microsoft Corporation, Keynote® from Apple, and Slides from Google, is used for inserting text and graphics onto individual slides to create slide presentations. Presentation software can be run on a regular desktop or laptop computer, making the creation of slide presentations convenient and straightforward.

Slide presentations are typically used for visually communicating information during a speech or presentation. Slide presentations can be used for purposes relating to business, education, entertainment, etc. Some benefits of utilizing slide presentations include helping the speaker follow an outline of a speech and providing visual information that can help the audience follow the main points of the speech.

To create a slide presentation, a user might need to access a file system associated with the business with which the user is employed, download presentations that may have been saved on the file system, and search for relevant content on the Internet or other networks. After gathering information from various sources, the user may realize that the content might not be useful for the user's particular purpose. Although some information downloaded from an organization's network might be useful for one purpose, the same information might not be so useful for other purposes with a different audience. A user may spend numerous hours searching for the content to use in presentations to convey ideas or answer questions relevant to their audience.

Similarly, a user may have saved numerous presentations from various sources on their laptop or desktop computer. To draft a new slide presentation, a user may open and close many presentation decks looking for the content relevant to the new presentation deck. A user may not recall where the relevant content resides or if it even exists. Numerous hours can be spent searching for relevant content or drafting new slides that provide the information a user wants to capture in a new presentation deck.

Systems, methods, and software applications for using machine learning to auto-generate presentations, slides, and answers are described in the present disclosure. According to one embodiment, among many, an artificial intelligence assistant computing facility is configured to perform machine learning and store instructions that are executable by a processing device to enable a user to create a new slide presentation, find relevant slides, discover related content, generate answers to questions from existing slides, accept text and image suggestions to personalize slides, and view assembled slides and presentations. The artificial intelligence assistant computing facility comprises logic adapted to perform an ensemble of machine learning models to work in tandem for classifying, editing, and generating content. The artificial intelligence assistant computing facility includes logic adapted to process and classify content, determine the similarity of each slide, suggest slides for inclusion in a presentation, and offer recommendations for editing the content. The artificial intelligence assistant computing facility also includes logic adapted to answer questions posed by a user. One or more queries entered by a user via a graphical question and answer (Q&A) user interface initiates a text search of individual slides and processing of deep learning and generative AI technology to auto-generate answers based on extracted data. The artificial intelligence assistant computing facility includes logic adapted to extract information from each slide. Additional logic is adapted to use an ensemble of deep learning models to edit slides inline based on AI recommendations for text and images. The artificial intelligence assistant computing facility includes logic adapted to compose new slides based on the context provided by slides added by a user. The artificial intelligence assistant computing facility also includes logic adapted to auto-create a new presentation, which can include one or more slides assembled by the system.

The present disclosure describes several embodiments of systems, methods, and processing logic for managing presentation content. Regarding one particular embodiment, an artificial intelligence assistant computing facility, which is configured to perform machine learning and store instructions that are executable by a processing device, includes logic adapted to perform an ensemble of deep learning models and generative AI technology to generate content automatically.

The artificial intelligence assistant computing facility may be a server, a network of servers, a computer, a network of computers, a mobile device such as a laptop, a tablet, a smart phone, other smart devices, or a network of mobile devices, or similar electronic devices. The artificial intelligence assistant computing facility illustratively includes a processor, a memory in communication with the processor, a user interface (including an input device (e.g., a keyboard) and/or an output device (e.g., a display)) and some combination of logical modules for execution by the processor.

The artificial intelligence assistant computing facility includes logic adapted to extract and process the slide presentations into individual slides, create files defining specific signature information about the slides and the presentation, and perform a series of processes to generate thumbnails for each slide, perform name entity resolution and sentiment analysis, count, and classify the content. The artificial intelligence assistant computing facility includes logic adapted to enable a user to create a new slide presentation, discover content to include in assembling a new presentation, get AI-generated answers based on processed content from uploaded presentations, edit slides using AI-generated text and image recommendations, view AI-generated slides auto-created based on the context provided by processed content, and view assembled slides and presentations.

The artificial intelligence assistant computing facility includes logic adapted to enable a user to enter one or more search terms via a graphical user interface. One or more search terms are used to initiate a text search of individual slides extracted and processed by the system. The artificial intelligence assistant computing facility includes logic to display results of the text search on the graphical user interface, which shows a thumbnail visual representation of a plurality of the individual slides resulting from the text search. The artificial intelligence assistant computing facility also includes logic adapted to enable a user to like, add to a list, or share slides.

The artificial intelligence assistant computing facility includes logic adapted to process content from individual slides in a plurality of slide presentations, including classifying the content into various categories such as concepts, companies, and people. The artificial intelligence assistant computing facility also includes logic adapted to determine the similarity of each slide with consolidated groups of slides with similar attributes from other slide presentation decks.

The artificial intelligence assistant computing facility comprises logic to perform an ensemble of deep learning models to auto-generate a new presentation. Each slide in the suggested slides for inclusion in an auto-generated presentation deck is contextual to the user's actions and relation/similarity context. The artificial intelligence assistant computing facility includes logic to display text and image recommendations to tailor the slide based on an ensemble of machine learning models. The artificial intelligence assistant computing facility includes logic adapted to auto-create new slides from the context provided by slides already added to the presentation by applying machine learning and generative AI technology. The artificial intelligence assistant computing facility also includes logic adapted to auto-create a new presentation based on content from saved lists or liked slides as well from scratch. Additional logic incorporates user input along with an ensemble of deep learning models to determine the best order of slides in the new presentation deck.

The artificial intelligence assistant computing facility includes logic adapted to answer questions posed by a user from extracted signature information about a plurality of individual slides. One or more questions can be entered in the search box via a graphical user interface. The artificial intelligence assistant computing facility includes logic to display answers and associated relevant slides on the graphical user interface. The artificial intelligence assistant computing facility also comprises logic adapted to auto-create a slide based on the system-provided answers liked by a user, AI recommendations for text and images, and/or user edits.

According to an illustrative embodiment of the present disclosure, a method of electronic presentation assistance includes receiving, via an artificial intelligence assistant computing facility or a component or a module thereof, one or more presentations made available by a first user, the one or more presentations including slides. Illustratively, the artificial intelligence assistant computing facility includes a content auto-generation and organization module and an application user interface. This step is illustratively executed by a document extractor and a document processor of a slide content extraction module which, in turn, forms part of the content auto-generation and organization module.

The illustrative method further includes receiving, via the artificial intelligence assistant computing facility or a component or a module thereof, a request from a second user to generate specific content from information extracted from the one of more presentations. This step is illustratively executed by an artificial intelligence (AI) engine, and a content assembly module having a presentation auto-assembly module, a slide auto-creation module, a category classification module, a slide metadata classification module, a content quality module, a sentiment analysis module, a question and answers module, an AI summary module, a text suggestion module, an image suggestion module, a slide suggestion module and a slide similarity module.

The illustrative method further includes analyzing, via the artificial intelligence assistant computing facility or a component or a module thereof, the one or more presentations to classify data and metadata for the slides. This step is illustratively executed by the AI engine, and the category classification module, the slide metadata classification module, the content quality module and the sentiment analysis module of the content assembly module.

The illustrative method further includes generating, via the artificial intelligence assistant computing facility or a component or a module thereof, a summary for each of the one or more presentations. This step is illustratively executed by the AI engine, and the AI summary module of the content assembly module.

The illustrative method further includes determining, via the artificial intelligence assistant computing facility or a component or a module thereof, similarities in content of the one or more presentations. This step is illustratively executed by the AI engine, and the slide similarity module of the content assembly module.

The illustrative method further includes determining, via the artificial intelligence assistant computing facility or a component or a module thereof, and based on the second user request, a response to the second user request. Illustratively, an application orchestrator invokes the AI engine to process the user request. More particularly, this step is executed by the AI engine, and components of a user responsive module and the content assembly module. Components of the user responsive module illustratively include a presentation upload module, a graphical user interface module, a search request module, a search results display module, a like processing module, a list processing module, a tagging module, a thumbnail display module, a content share module, a presentation editing module, a presentation download module, and a concepts selection module. Components of the content assembly module illustratively include the presentation auto-assembly module, the slide auto-creation module, the question and answer module, the AI summary module, the text suggestion module, the image suggestion module, the slide suggestion module, and the slide similarity module.

Illustratively, the slide content extraction module reprocesses the response from the content auto-generation and organization module and sends it to the application user interface. The application user interface renders the response to the second user, illustratively via a display.

The illustrative method further includes predicting content edits based at least in part on the second user requests and reaction to suggestions made via the artificial intelligence assistant computing facility or a component or a module thereof. This step is illustratively executed by the AI engine, and the text suggestion module, the image suggestion module and the slide suggestion module of the content assembly module.

The illustrative method further includes generating a composition change to a slide in a presentation by the second user, via the artificial intelligence assistant computing facility or a component or a module thereof, and based at least in part on the second user request, presentation context, and predicted reaction. This step is illustratively executed by the AI engine, and the slide auto-creation module of the content assembly module.

The illustrative method further includes generating a compositional change to a slide in the presentation by the second user, via the artificial intelligence assistant computing facility or a component or a module thereof, and based at least in part on the second user request, presentation context, and predicted reaction. This step is illustratively executed by the AI engine, and the presentation auto-assembly module of the content assembly module.

According to a further illustrative embodiment of the present disclosure, a system for electronic presentation assistance includes an artificial intelligence assistant computing facility having at least one processor, and a memory device storing software configured to cause the at least one processor to receive one or more presentations having a slide made available by a first user. Illustratively, the artificial intelligence assistant computing facility includes a content auto-generation and organization module and an application user interface. The content auto-generation and organization module illustratively includes a document extractor and a document processor of a slide content extraction module.

The illustrative system is further configured to receive a request from a second user to generate specific content from information extracted from the one or more presentations. This function is illustratively executed by an artificial intelligence (AI) engine, and a content assembly module having a presentation auto-assembly module, a slide auto-creation module, a category classification module, a slide metadata classification module, a content quality module, a sentiment analysis module, a question and answers module, an AI summary module, a text suggestion module, an image suggestion module, a slide suggestion module and a slide similarity module.

The illustrative system is further configured to analyze the one or more presentations to classify data and metadata for each slide of the one or more presentations. This function is illustratively executed by the AI engine, and the category classification module, the slide metadata classification module, the content quality module, and the sentiment analysis module of the content assembly module.

The illustrative system is further configured to generate a summary for each of the one or more presentations. This function is illustratively executed by the AI engine, and the AI summary module of the content assembly module.

The illustrative system is further configured to determine content similarities between the one or more presentations. This function is illustratively executed by the AI engine, and the slide similarity module of the content assembly module.

The illustrative system is further configured to predict a content edit based at least in part on the second user request and a reaction to suggestions by the second user. This function is illustratively executed by the AI engine, and the text suggestion module, the image suggestion module and the slide suggestion module of the content assembly module.

The illustrative system is further configured to generate a compositional change to a slide constructed to respond to the second user request based at least in part on a presentation context and a predicted reaction. This function is illustratively executed by the AI engine, and the slide auto-creation module of the content assembly module.

The illustrative system is further configured to generate a compositional change to a presentation constructed to respond to the second user request based at least in part on a presentation context and a predicted reaction. This function is illustratively executed by the AI engine, and the presentation auto-assembly module of the content assembly module.

According to another illustrative embodiment of the present disclosure, a system for electronic presentation assistance includes an artificial intelligence assistant computing facility having at least one processor, and a memory device storing software configured to cause the at least one processor to receive one or more presentations having a slide made available by a first user. Illustratively, the artificial intelligence assistant computing facility includes a content auto-generation and organization module and an application user interface. The content auto-generation and organization module illustratively includes a document extractor and a document processor of a slide content extraction module.

The illustrative system is further configured to receive a request from a second user to answer a specific question from information extracted from the one or more presentations. This function is illustratively executed by an artificial intelligence (AI) engine, and a content assembly module, having a presentation auto-assembly module, a slide auto-creation module, a category classification module, a slide metadata classification module, a content quality module, a sentiment analysis module, a question and answers module, an AI summary module, a text suggestion module, an image suggestion module, a slide suggestion module and a slide similarity module.

The illustrative system is further configured to analyze the one or more presentations to classify data and metadata for each slide of the one or more presentations. This function is illustratively executed by the AI engine, and the category classification module, the slide metadata classification module, the content quality module, and the sentiment analysis module of the content assembly module.

The illustrative system is further configured to generate a summary for each of the one or more presentations. This function is illustratively executed by the AI engine, and the category classification module, the slide metadata classification module, the content quality module and the sentiment analysis module of the content assembly module.

The illustrative system is further configured to generate from information extracted from the one or more presentations a human-readable answer to the specific question posed by the second user. This function is illustratively executed by the AI engine, and the question and answer module of the content assembly module.

Other features, advantages, and implementations of the present disclosure, not expressly disclosed herein, will be apparent to one of ordinary skill in the art upon examination of the following detailed description and accompanying drawings. It is intended that such implied implementations of the present disclosure be included herein.

### BRIEF DESCRIPTION OF THE DRAWINGS

The components of the following figures are illustrated to emphasize the general principles of the present disclosure. Reference characters designating corresponding components are repeated as necessary throughout the figures for the sake of consistency and clarity.

A detailed description of the drawings particularly refers to the accompanying figures, in which:

FIG. 1 is a diagram illustrating an artificial intelligence assistant computing facility according to one embodiment.

FIG. 2 is a block diagram illustrating the artificial intelligence assistant computing facility executed by the end-user devices shown in FIG. 1, according to one embodiment.

FIG. 3 is a block diagram illustrating the document extractor module shown in FIG. 1, according to one embodiment.

FIG. 4 is a diagram illustrating a slide content extraction system according to one embodiment.

FIG. 5 is a block diagram illustrating the AI Engine shown in FIG. 1, according to one embodiment.

FIG. 6 is a block diagram illustrating the application orchestrator shown in FIG. 1, according to one embodiment.

FIG. 7 is a diagram illustrating an example of a graphical user interface (“GUI”) for enabling a user to search and discover slides, according to one embodiment.

FIG. 8 is a diagram illustrating an example of a GUI for enabling a user to auto-create a presentation with AI-suggested content, according to one embodiment.

FIG. 9 is a diagram illustrating an example of a GUI for enabling a user to dynamically edit and author a new presentation deck using AI-suggested and AI-generated slides, according to one embodiment.

FIGS. 10A-10C are diagrams illustrating an example of a GUI for enabling a user to auto-create a new slide with AI-generated content, according to one embodiment.

FIGS. 11A and 11B are diagrams illustrating an example of a GUI for enabling a user to discover similar content, according to one embodiment.

FIG. 12 is a diagram illustrating an example of a GUI for enabling a user to ask questions and find answers and associated slides, according to one embodiment.

FIG. 13 is a diagram illustrating an example of a GUI for enabling a user to find the newly created presentation in the system, according to one embodiment.

FIG. 14 is a diagram illustrating an example of a GUI for enabling a user to ask questions and find answers located on charts and tables embedded in slides, according to one embodiment.

FIG. 15 is a flow diagram illustrating a method of an end-user device of an artificial intelligence assistant computing facility for enabling a user to create a new presentation deck from existing presentations, according to one embodiment.

FIG. 16 is a flow diagram illustrating a method of an end-user device of an artificial intelligence assistant computing facility for enabling a user to create a new presentation deck from discovered content, according to one embodiment.

FIG. 17 is a flow diagram illustrating a method of an end-user device of an artificial intelligence assistant computing facility for enabling a user to create a new presentation from answers found in slide content, according to one embodiment.

FIG. 18 is a flow diagram illustrating a method of an end-user device of an artificial intelligence assistant computing facility for enabling a user to find similar slides and presentations, according to one embodiment.

FIG. 19 is a flow diagram illustrating a method of an end-user device of an artificial intelligence assistant computing facility for enabling a user to find answers from slide content to create a new slide, according to one embodiment.

FIG. 20 is a flow diagram illustrating a method of an end-user device of an artificial intelligence assistant computing facility for enabling a user to discover answers in slide content to learn and increase knowledge, according to one embodiment.

FIG. 21 is a diagram illustrating an example of a graphical user interface (“GUI”) for enabling a user to view extracted content from slides, according to one embodiment.

FIG. 22 is a diagram illustrating an example of a GUI for enabling a user to view organized and classified content from slides, according to one embodiment.

FIG. 23 is a diagram illustrating an example of a GUI for enabling a user to view summarized content from slides, according to one embodiment.

FIG. 24 is a diagram illustrating an example of a GUI for enabling a user to view multiple versions of a single instance of content from slides, according to one embodiment.

FIG. 25 is a diagram illustrating an example of a GUI for enabling a user to view similar slides or presentations, according to one embodiment.

FIG. 26 is a diagram illustrating an example of a GUI for enabling a user to find slide content matching the search query, according to one embodiment.

FIG. 27 is a diagram illustrating an example of a GUI for enabling a user to find the most relevant slide and the best sentence matching the search query, according to one embodiment.

FIG. 28 is a diagram illustrating an example of a GUI for enabling a user to view statistics on the readability of each slide, according to one embodiment.

FIG. 29 is a diagram illustrating an example of a GUI for enabling a user to view a collection of slides and individual slide details, according to one embodiment.

FIG. 30 is a diagram illustrating an example of a GUI for enabling a user to view statistics on content library artifacts, according to one embodiment.

FIG. 31 is a flow diagram illustrating a method of an end-user device of an artificial intelligence assistant computing facility for surfacing documents by combining the quality (readability), authority (authoring), freshness (recency), relevancy (semantic matching), popularity (number of clicks) of each slide in the content library, according to one embodiment.

FIG. 32 is a flow diagram illustrating a method of an end-user device of an artificial intelligence assistant computing facility for presenting a user with key metrics about slide content in the content library, according to one embodiment.

### DETAILED DESCRIPTION OF THE DRAWINGS

The embodiments of the invention described herein are not intended to be exhaustive or to limit the invention to precise forms disclosed. Rather, the embodiments selected for description have been chosen to enable one skilled in the art to practice the invention.

### I. Introduction

When creating a slide presentation, a user may need to access information from various sources. Not only can researching and gathering relevant information for the presentation be time-consuming but sifting through a vast amount of data to determine what information is suitable can reduce productivity. After this, the user may spend a significant amount of time creating a slide presentation, especially if the user does not have much experience in this regard.

To improve the processes for creating a slide presentation compared to conventional preparation techniques, the embodiments of the present disclosure comprise the establishment of a system that allows the extraction and processing of existing slide presentation content to auto-generate new content. The present disclosure streamlines the process of creating new slides and new presentations by tapping into natural language processing and deep learning to find the correct content and generate a new presentation using system-generated recommendations. A user can save numerous hours searching for the right presentation, slide, or answer. In some cases, a user may not be able to find the information they are looking for manually. The impact of the benefits of utilizing the artificial intelligence assistant computing facility in terms of hours and improved quality can be substantial for individuals and organizations.

Even though numerous presentation content can be made available to users, it may still be difficult for a user to determine the significance or usefulness of certain slide presentations. However, with a content auto-generation and organization system, a user can enter a question to find content within existing slides. Also, the user can view the metadata for slides and presentations that are revealed during the search, which can help to determine the recency and relevancy of the presentation content for his/her purposes. Therefore, the user has quick access to answers and content to include in the new presentation.

In some embodiments, features of the present invention are implemented, in whole or in part, in the cloud as part of, or as a service of, a cloud computing system based on shared, elastic resources delivered to users in a self-service, metered manner using Web technologies. There are five characteristics of the cloud (as defined by the National Institute of Standards and Technology: on-demand self-service; broad network access; resource pooling; rapid elasticity; and measured service. Cloud deployment models include Public, Private, and Hybrid. Cloud service models include Software as a Service (SaaS), Platform as a Service (PaaS), Database as a Service (DBaaS), and Infrastructure as a Service (IaaS). As used herein, the cloud is the combination of hardware, software, network, and web technologies that deliver shared elastic resources to users in a self-service, metered manner. Unless otherwise specified, the cloud, as used herein, encompasses public cloud, private cloud, and hybrid cloud embodiments, and all cloud deployment models including, but not limited to, cloud SaaS, cloud PaaS, cloud DBaaS, and cloud IaaS. Users can log in by entering their credentials from the cloud presentation content auto-generation and organization application to access a graphical user interface to indicate the files to be processed. An alternative mode of access is for a user to install the presentation content auto-generation and organization application on their local computer to indicate the directories to be scanned. In all modes of presentation content auto-generation and organization application implementation, users can discover slides and search for answers to be included in the auto-generated slides or presentations.

During assembly, the presentation template determined either by a user or the system based on usage is leveraged in order to maintain the formatting and styling of every slide in a new auto-created presentation. The slides are placed in the proper sequence, determined by an ensemble of deep learning models and the user's actions. Once the slides are auto generated, the user can review, edit, or enhance the content according to the user's needs using conventional presentation software processing means.

### II. Example Architecture

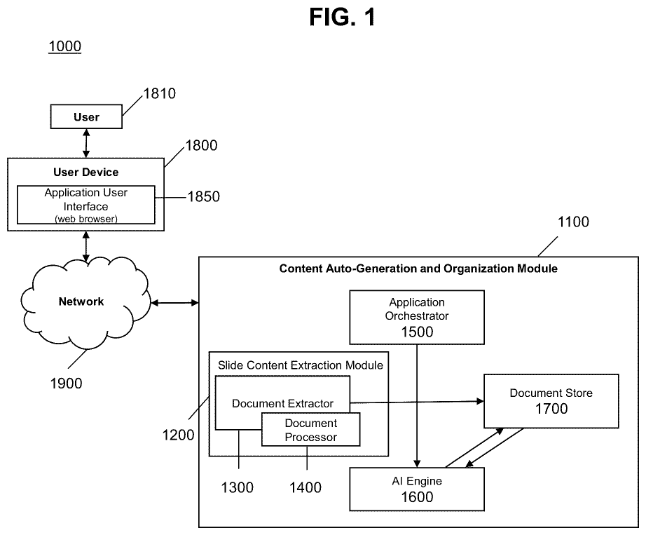

FIG. 1 is a diagram illustrating an embodiment of an artificial intelligence assistant computing facility or system 1000. In this embodiment, the artificial intelligence assistant computing facility 1000 includes a content auto-generation and organization module or device 1100 illustratively having a document extractor 1300, a document processor 1400, a document store 1700, an application orchestrator 1500, and an Artificial Intelligence (AI) Engine (skills module) 1600. The content auto-generation and organization module 1100 is illustratively in communication with an application user interface 1850 of a user device 1800.

The slide content extraction module 1200 is comprised of the document extractor 1300 and the document processor 1400 to process slides from presentations. The document extractor 1300 is responsible for scanning data sources (including a disk drive, emails, collaboration tools, or uploaded documents) for presentation files and extracting content and metadata. The extracted content is passed to the document processor 1400 for further application of natural language processing (NLP) and machine learning (ML) to prepare the content for auto-generation. Additionally, the artificial intelligence assistant computing facility 1000 organizes extracted and processed content in a user-intuitive format to enable a user 1810 to easily select the slide and content to incorporate in the new presentation. The processed content is passed to the document store 1700, which acts as a repository and a text search engine for the extracted content and associated metadata. The application orchestrator 1500 is responsible for managing every command administered by the artificial intelligence assistant computing facility 1000 and orchestrating the flow of information across all components, including a user device or machine 1800 including an application user interface or presentation layer 1850, the document extractor 1300, the document store 1700, and the AI Engine 1600. The AI Engine 1600 is responsible for the question-and-answer system, content auto-generation, presentation auto-generation, and presentation and slide classification. The application presentation layer 1850 presents the user 1810 with an interface to operate and administer all aspects of the application. The application user interface 1850 is accessible via a browser or a native desktop application on the user's local computer. Such user interface 1850 device may include a user input (e.g., a keyboard) and/or an output device (e.g., a display).

Content auto-generation and organization module 1100 may be a server, a network of servers, a computer, a network of computers, a mobile device such as a laptop, a tablet, a smart phone, other smart devices, or a network of mobile devices, or similar electronic devices. The content auto-generation and organization module 1100 illustratively includes a processor, a memory in communication with the processor, and some combination of logical modules for execution by the processor. The user device 1800 illustratively includes a user interface 1850 (including an input device (e.g., a keyboard)) and/or an output device (e.g., a display)).

Content auto-generation and organization module 1100 and user device 1800 can communicate over a network 1900, which can include, for example, the Internet, a local area network (LAN), a wide area network (WAN), and so on. It will be appreciated that various alternatives to the depicted and described embodiments are contemplated. For example, some or all of the machine learning may be performed at the content auto-generation and organization module 1100. Content auto-generation and organization module 1100 may periodically receive presentation files to process using machine-learning techniques.

The user's local computer or device 1800 may be a computing system, such as a desktop, a network of desktops, a mobile device such as a laptop, a tablet, a smart phone, other smart devices, or a network of mobile devices, or similar electronic devices for executing logic instructions. The artificial intelligence assistant computing facility 1000 is configured to gather presentation documents from the user's local computer (email, collaboration tools, etc.), cloud storage service, cloud content management systems, or files previously uploaded to the user's cloud account.

Artificial intelligence assistant computing facility 1000 processes the slide presentations into individual slides, creates files defining specific signature information about the slides and the presentation, and performs a series of processes to generate thumbnails for each slide, perform name entity resolution and sentiment analysis, count, and classify the content. The artificial intelligence assistant computing facility 1000 is further configured to provide search functionality to allow users 1810 to conduct text searches with questions the user 1810 wants to be answered. The artificial intelligence assistant computing facility 1000 can also store and manage metadata associated with the respective presentations, slides, and sentences. Metadata captured for presentations include last access time, creation time, file name, first slide title, first slide subtitle, company name, and author name. The artificial intelligence assistant computing facility 1000 also stores an AI-generated summary of the presentation. The artificial intelligence assistant computing facility 1000 captures a host of metadata for each slide, including entities mentioned, the richness of the content, and overall sentiment. At the sentence level, metadata such as text, font details, number of words, and sentiment of each sentence are captured. For each presentation and slide, the AI Engine 1600 will classify the content for a top-level category such as “sales”, “product introduction”, etc. as well as child-level category such as “sales pitch”, “product value proposition”, etc. Furthermore, the AI Engine 1600 will determine the quality of the slide. When the content context is captured, the artificial intelligence assistant computing facility 1000 can use existing slides to generate a new presentation using the same styling and template and correctly arrange the order of the slides. The artificial intelligence assistant computing facility 1000 will learn from existing presentations' top-level and child-level categories to compile a new presentation.

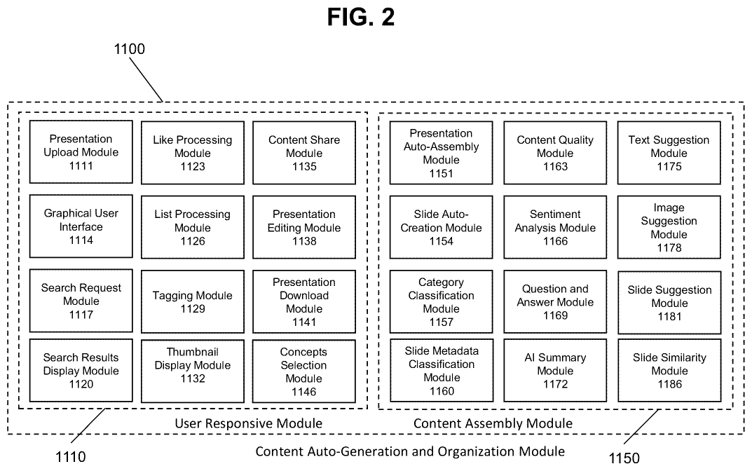

FIG. 2 is a block diagram illustrating an embodiment of a presentation content auto-generation and organization module 1100 shown in FIG. 1, according to one implementation.

In this embodiment, the presentation content auto-generation and organization module 1100 includes a content assembly module 1150 and a user responsive module 1110. User responsive module 1110 includes, among other things, a presentation upload module 1111, a number of graphical user interfaces (GUIs) 1114, a search request module 1117, a search results display module 1120, a like processing module 1123, a list processing module 1126, a tagging module 1129, a thumbnail display module 1132, a content share module 1135, a presentation editing module 1138, a presentation download module 1141, and a concepts/category selection module 1146. Content assembly module 1150 includes, among other things, a presentation auto-assembly module 1151, a slide auto-creation module 1154, a category classification module 1157, a slide metadata classification module 1160, a content quality module 1163, a sentiment analysis module 1166, a question-and-answer module 1169, an AI summary module 1172, a text suggestion module 1175, an image suggestion module 1178, a slide suggestion module 1181, and a slide similarity module 1186.

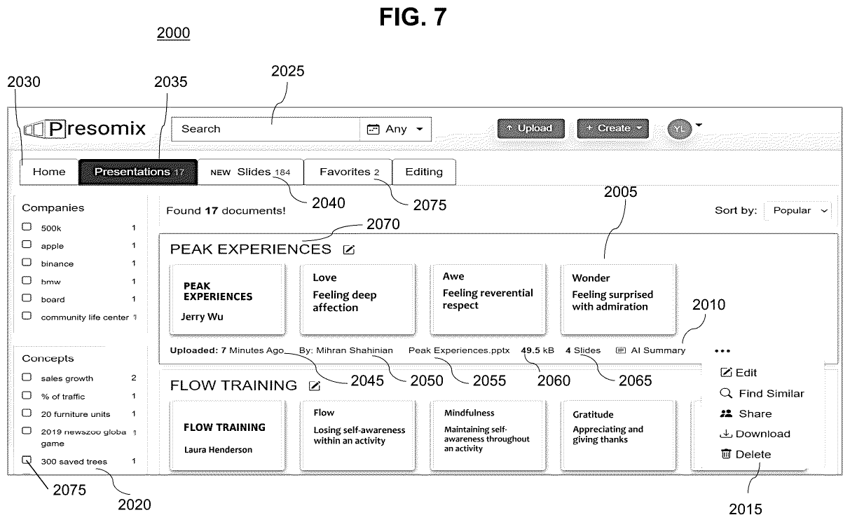

The user interacts with the user responsive module 1110 via graphical user interfaces 1114. GUIs 1114 are associated with the content auto-generation and organization system 1000 for displaying slide and presentation information to the user and for enabling the user to interact with the system for various actions, including conducting a text search, filtering content, entering social metadata, selecting slides, editing slides, downloading, and uploading slide presentations. GUIs 1114 are shown with respect to FIGS. 7-14, as described more fully below. By interacting with the content auto-generation and organization system GUIs 1114, a user can select files to upload or directories to be scanned. The presentation upload module 1111 operates in the background to extract and process the files. The processed data is captured in the document store, which is implemented as a text search engine and is configured to store presentations, individual slides, sentences, and information related to the presentations and slides. The presentation upload module 1111 is responsible for creating image files and text files associated with each slide. The image files may include at least one thumbnail image and at least one full-scale image having a higher resolution than the thumbnail image. The text files may consist of all the text that is displayed in the respective slides. Also, other files may be created in this process, such as data related to formatting information of each slide as well as shared information throughout a selected presentation.

The search request module 1117 incorporates the search engine and enables a user to enter a request to conduct a text search of terms or phrases. The search engine matches the user's search question with answers extracted from the slides. The text search can be performed to find slides, sentences, or values that match the particular search terms or answer the specific questions entered by the user. Also, the search can find slides that have associated social metadata tags that match the search terms or phrases.

The search results display module 1120 can arrange the answers in an order based on various factors, including, among other things, relevancy, and recency, and is configured to operate with GUIs 1114 to display the content in a particular fashion on GUIs 1114. When a presentation file is uploaded, thumbnails for each slide are generated, making it easier to search and verify the content. The search results display module 1120 allows the user to view individual slides and their associated metadata as well as a collection of slides. The search results display module 1120 also shows templates, logos, and related content processed from the scanned files, including fonts, colors, word count, and content. The search results display module 1120 may include various arrangements of content and thumbnail images, including carousels, cards, and lists.

The like processing module 1123 is configured to show if the user provided a signal that he/she liked the slide. If the like indicator is selected for a slide, its content is noted to be included in the presentation and slide creation process. This signal, along with other metadata, is fed back to the machine learning models for continuous feedback.

The list processing module 1126 saves the selected slides in a list defined by the user. Similar to liked slides, selecting slides to include in saved lists provides a signal of the user's interest in the content. This insight is fed back to the machine learning models for content auto-generation.

The tagging module 1129 is configured to show if the user added keywords or terms to a slide in order to find the slide easily and include it in a new presentation.

The thumbnail display module 1132 shows a compressed preview image of the original slide so the user can quickly and easily view all the slides displayed on the user interface or included in a presentation deck or a search query.

The content share module 1135 allows the user to share slides or presentations with other users of the system.

The presentation editing module 1138 allows users to select the slides to include in a deck, which may include various methods such as dragging-and-dropping or clicking on a slide as well as adding a slide to saved lists or favorites. The presentation editing module 1138 also handles and processes the user's input to modify the text and images of content included in the generation of a new slide or presentation.

The presentation download module 1141 manages the saving of a newly generated slide or presentation and downloading of all content in the system. Once the user provides the presentation name and selects to save the new content, the presentation download module 1141 processes the request and displays the newly generated content in the system. When the user initiates a request to download a slide or a presentation, the presentation download module 1141 transfers the content to the user's requested location on their computer. The user can view the content in a presentation software such as PowerPoint to further make edits and present.

The concept selection module 1146 allows the user to quickly filter content based on how the AI Engine 1600 classified the content for different concepts/categories. The user interactions with the concepts selection module 1146 can work in conjunction with an ensemble of deep learning models to auto-generate the proper sequence of slides in a new presentation deck.

The presentation auto-assembly module 1151 operates in the background to prepare the content for auto-assembly and includes a collection of document processors designed to work together to analyze, enrich, and tag content. The presentation auto-assembly module 1151 generates a new presentation based on topics and categories learned from existing presentations. The presentation auto-assembly module 1151 incorporates slide templates and styling based on relevancy, recency, and popularity. The user can also select a specific template to be used for auto-generation. The presentation auto-assembly module 1151 correctly arranges the order of slides and incorporates the best content associated with topics and categories requested by the user. A generative artificial intelligence mechanism is utilized to arrange a list of slides the user designated in an optimized sequence. Furthermore, the presentation auto-assembly module 1151 is equipped to enhance and refine the content, ensuring conciseness in alignment with the user's stipulated preferences to generate the final presentation.

The slide auto-creation module 1154 assembles a slide based on questions posed by a user via the user responsive module and answers found through a search of processed content. The slide auto-creation module 1154 uses an ensemble of deep learning algorithms to auto-generate a new slide based on extracted data relevant to the question posed by a user. The slide auto-creation module 1154 also composes a new slide from the context provided by slides already added by a user by applying natural language processing and generative AI technology. The AI engine 1600 employs metadata extracted from the slide content, in conjunction with a quality score assigned by the system. Utilizing these parameters, the AI engine 1600 formulates a suitable input for a generative artificial intelligence mechanism, with the primary objective of refining and optimizing the content of the slide.

The category classification module 1157, slide metadata classification module 1160, content quality module 1163, and sentiment analysis module 1166 are performed in the background without the user's knowledge. The category classification module 1157 leverages a wide range of machine learning techniques to process content into relevant topics and subtopics. A top-level category such as “sales” or “business plan” as well as child-level categories like “Q4 sales projection” or “executive summary” is processed for each presentation and associated slides. Relevant entities such as company, proper, and product names, as well as logos and other relevant content, are classified for use in the auto-creation of slides and presentations.

The slide metadata classification module 1160 categorizes each slide based on its function, such as title, disclaimer, main body, and thank you, based on various factors such as content, format, usage, and order. A presentation may have certain slides that are common to many presentations, such as Q&A and thank you slides that are not rich in content. The slide metadata classification module 1160 also tags a slide as high, medium, or low value based on analysis of content value, relevancy to topic/subtopics, the order of appearance in a deck, and usage across multiple presentations.

The content quality module 1163 classifies a wide range of factors such as the ratio of visuals to text, font size, sentiment, and slide value to indicate to the user the overall quality of the slide. The content quality module 1163 classifies each slide based on the richness of content as well as the richness of visuals. The content quality module 1163 also analyzes the percentage of content occupying the screen as well as the number of words on each slide. Content quality for each slide is determined utilizing an ensemble of machine learning techniques.

The sentiment analysis module 1166 uses natural language processing to detect the sentiment of each sentence and the overall sentiment of a slide based on sentence-level sentiments. The content auto-generation and organization system 1000 provides visual signals to the user if the slide or sentence has a positive, negative, or neutral message.

The question-and-answer module 1169 uses natural language processing, natural language generation, and neural nets to match the user's questions with answers extracted from slide text and charts. Users can ask questions in a conversational format, and the system will respond in a conversational tone using natural language generation along with the slide where the answer was found. Generative AI technology is employed to interpret and process the intent of the user. This intent is subsequently compared and matched against a repository of pre-existing content. Based on this match, suitable input is formulated to facilitate a response generated by the artificial intelligence mechanism.

The AI summary module 1172 uses natural language generation to provide a summary of the content captured in the presentation deck. The AI summary module 1172 uses text-to-text generation models to compile a concise summary of the presentation content.

The text suggestion module 1175 uses natural language processing, natural language generation, neural nets, and machine learning to recommend improvements to the wording used in a slide. The text suggestion module 1175 also provides paraphrasing and grammar checks for the content on each slide. When the user selects text recommendations from a plurality of text suggestions, the text suggestion module incorporates the updates selected by the user to aid in tracking the number of changes and improving text recommendations.

The image suggestion module 1178 uses image recognition, neural nets, and machine learning to suggest images that are relevant to the text in a slide to use. When the user selects image recommendations from a plurality of image suggestions, the image suggestion module incorporates the updates selected by the user to aid in tracking the number of changes and improving image recommendations.

The slide suggestion module 1181 uses machine learning, neural nets, natural language processing, and image recognition to recommend slides to include in a presentation deck that is being created or edited. The slide suggestion 1181 module generates a suggested slide sequence based on topic similarity, usage frequency, presentation metadata similarity, and desired length of the presentation.

The slide similarity module 1186 uses the extracted information from each slide to find slides that are similar across the multiple presentations that were scanned. The slide similarity module 1186 displays comparable slides as a group to assist the user in finding the best content and simplify a display of multiple copies of the same slides.

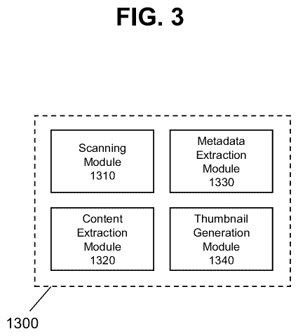

FIG. 3 is a block diagram illustrating an embodiment of the document extractor module 1300 shown in FIG. 1, according to one implementation. The document extractor module 1300 includes, among other things, a scanning module 1310, a content extraction module 1320, a metadata extraction module 1330, and a thumbnail generation module 1340. The scanning module 1310 is responsible for scanning the disk drive for the presentation. The content extraction module 1320 extracts content, and the metadata extraction module 1330 extracts metadata from these files. At the presentation level, metadata extracted includes author, file name, create date, last accessed date, number of slides, and template name. At the slide level, the content extraction module 1320 pulls the slide number, text with the location on the slide, font size, and color. The thumbnail generation module 1340 creates a thumbnail of the slides that were extracted. The document extractor module 1300 identifies font, color, shapes, and associated images from each slide. Furthermore, the document extractor module 1300 processes text and images from slides, charts, and graphs.

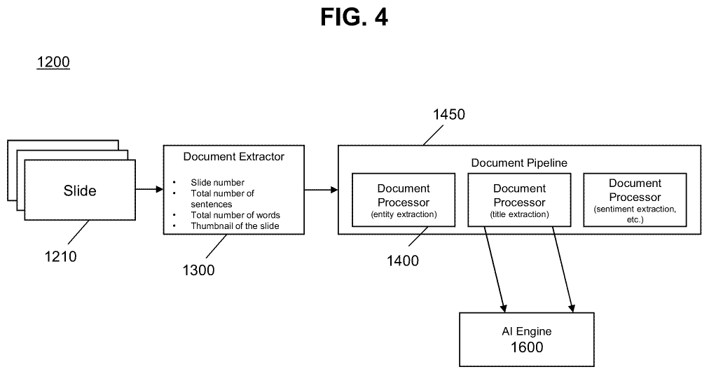

FIG. 4 is a diagram illustrating a slide content extraction module 1200 shown in FIG. 1, according to one implementation. In this embodiment, the slide content extraction module 1200 describes the processing of a slide 1210. When a slide 1210 is processed, the document extractor module 1300 captures the content, metadata, and thumbnail of the slide 1210. Metadata such as slide number, the total number of sentences, the total number of words as well as the content of the slide 1210 are passed to the document pipeline. The document pipeline 1450 is comprised of one or more document processors 1400, which are responsible for processing information extracted by the document extractor module and further applying natural language processing (NLP) and artificial intelligence (AI) to prepare the content for auto-generation. The document processors 1400 communicate with the AI engine 1600 to perform named entity resolution to find a company and general names as well as classify topics for each document. It 1400 interacts with the AI Engine 1600 to perform sentiment analysis on each slide 1210 to determine if it has a positive or negative message and classify each slide 1210 as content-heavy or visual-heavy. In addition, the document processors 1400 count the number of words on each slide 1210 and the percentage of content occupying the screen.

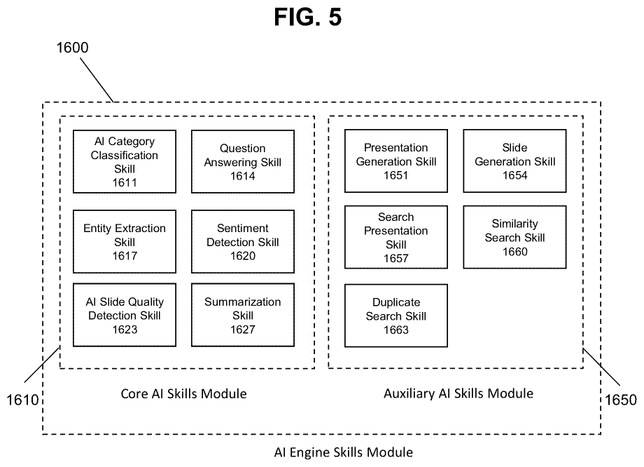

FIG. 5 is a block diagram further illustrating the AI Engine skills module 1600 shown in FIG. 1, according to one embodiment. In this embodiment, the AI Engine skills module includes a core AI skills module 1610 and an auxiliary AI skills module 1650. The AI Engine skills module 1600 powers the content auto-generation and organization module 1100 with an ensemble of deep learning algorithms. The core AI skills module 1610 includes, among other things, an AI category classification skill 1611, a question-answering skill 1614, an entity extraction skill 1617, a sentiment detection skill 1620, an AI slide quality detection skill 1623, and a summarization skill 1627. The auxiliary AI skills module 1650 includes the presentation generation skill 1651, slide generation skill 1654, search presentation skill 1657, similarity search skill 1660, and duplicate search skill 1663. These skills enable the capabilities of the content assembly module 1150 and the user responsive module 1110 shown in FIG. 2.

The AI category classification skill 1611 provides a category and subcategory for a particular slide. Based on the slide content, top-level categories can include an introduction or topics such as sales and training. For these categories, subcategories can consist of speaker biography, enterprise sales, or product training, respectively.

The question-answering skill 1614 returns the best possible answer to a natural language query. A user can ask questions such as “what was the revenue in North America for Q4 2020?” If there is content with the correct answer, the question-answering skill 1614 will display the response (e.g., Q4 2020 revenue in North America was $1.2 million) in the results UI and reference the slide where the answer was found. The question-answering skill 1614 locates the best answer by using search lookup to reduce the set of possible answers and then by using deep learning to analyze and extract the best possible answer from the search lookup document results. The user can like the proposed answer and mark the answer and associated slide for future reference.

The entity extraction skill 1617 extracts people, places, product names, and key phrases from unstructured text. The entities extracted are indexed with documents and presented to the users as options to filter their slides.

The sentiment detection skill 1620 produces a metric of the voice used in the slide and gives the user an indication of the tone used in the presentation. Categories of sentiments can include passive, call to action, positive, and negative.

The AI slide quality detection skill 1623 evaluates the slide quality based on a number of parameters, including the number of images used on the slide, the number of words used, the area of text covering the slide, the area of images covering the slide, contrast of colors, consistency with the theme used, and duplicate data presented.

The summarization skill 1627 generates a concise summary of the content captured in the presentation deck by using text-to-text generation models.

The presentation generation skill 1651 accepts and performs many presentation generation activities. It 1651 enables a user to create a new presentation by selecting, dragging and dropping, and reordering existing slides into a new presentation. The presentation generation skill 1651 composes a new presentation from user-selected slides where the presentation may contain singular or multiple slides. The presentation generation skill 1651 also composes a new presentation based on a user-selected topic using existing slides.

The slide generation skill 1654 accepts and performs many slide editing and generation activities. It 1654 enables the user to select text or image recommendations from a plurality of text or image suggestions. The user also has the ability to edit slides inline. The slide generation skill 1654 updates the actual slide during new presentation generation and displays original content and updated content in the notes section of the newly generated presentation. The slide generation skill 1654 also incorporates the user's historical interaction with the system to dynamically generate slides.

The search presentation skill 1657 performs a search against slides using keywords, natural language processing, and other machine learning techniques. The search presentation skill 1657 enables the ability to display personalized search results ranked by relevance based on the user's preference and past interactions. It 1657 also allows for interactive paging and filtering. The search presentation skill 1657 enables the user to filter the displayed and suggested slides.

The similarity search skill 1660 performs a search to find related slides and presentations and enables the user to view returned content. The similarity search skill 1660 relies on vector representations of text along with the slide metadata to find similar slides.

The duplicate search skill 1663 finds duplicate slides for a selected slide by the end-user.

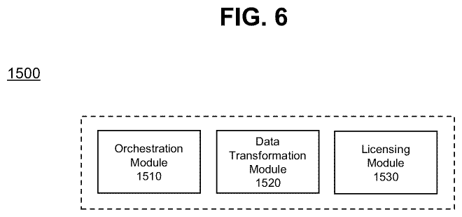

FIG. 6 is a block diagram illustrating the Application Orchestrator 1500 shown in FIG. 1, according to one embodiment. In this embodiment, the application orchestrator module 1500 includes, among other things, an orchestration module 1510, a data transformation module 1520, and a licensing module 1530.

The orchestration module 1510 is responsible for translating user input to system actions that tie the system together. These actions include acquiring content, scheduling, indexing data, performing deduplication, and natural language pre-processing of content.

The data transformation module 1520 is responsible for taking raw input in PowerPoint format, extracting, and transforming input into a format that is consumable by AI engine skills module 1600. The data transformation module 1520 also prepares the presentation for the end-user.

The licensing module 1530 manages user subscriptions and prevents unauthorized distribution of the software.

### III. Example Implementation

A. Machine-Licensing-Based Presentation Generation

FIG. 7 is a diagram illustrating an embodiment of a graphical user interface (GUI) 2000 for enabling a user to search and discover slides, according to one implementation.

In this embodiment, GUI 2000 displays content processed by the AI Engine 1600 in the Presentation tab 2035. The user 1810 can also view processed content from the Homepage 2030 and the Slides tab 2040. For each presentation deck, a user can see the presentation title 2070, uploaded date 2045, uploaded by 2050, file name 2055, file size 2060, and the number of slides 2065. The user 1810 can also see thumbnails of the slides 2005 comprising the presentation. In addition, the user 1810 can view an AI summary 2010 for an abstract of the content generated through natural language processing and natural language generation. In addition, the user 1810 can access a menu of actions 2015 such as edit, find similar, share, download, and delete. Relevant facets 2020 for the processed content are displayed on the left panel. A user can narrow down their search results by applying multiple filters 2075 based on the faceted classification of the slide contents.

GUI 2000 includes a text window with the search button 2025. The user 1810 can enter a search query in the search box 2025 to find relevant content, and the slides that match the query are highlighted. The user 1810 can find slides relevant to the search terms or answers to questions posed using the search box. Clicking on a particular slide will zoom in so a user can read the content details. The user 1810 can indicate if they like a specific slide by hovering over the slide and clicking on the heart icon. Liked slides appear in the Favorites tabs 2075 for quick reference for future use.

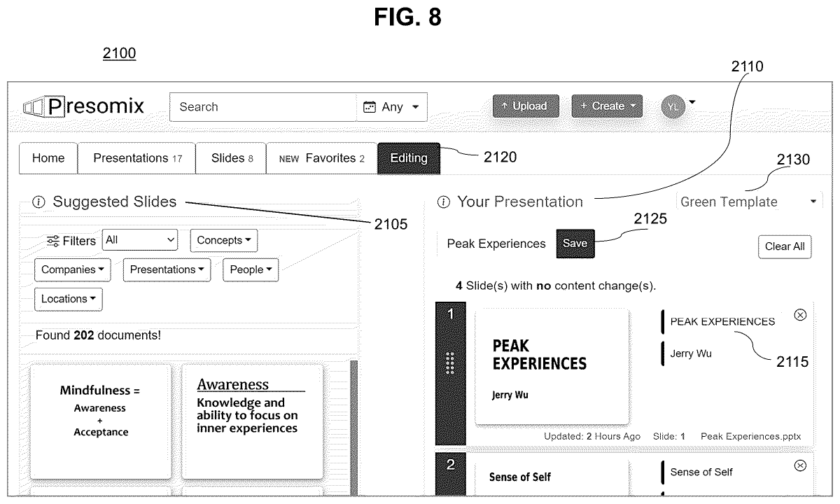

FIG. 8 is a diagram illustrating an embodiment of a graphical user interface (GUI) 2100 for enabling a user to auto-create a presentation with AI-suggested content, according to one implementation.

In this embodiment, GUI 2100 displays content when the user 1810 selects to edit a presentation. The slides from the original presentation and the slides suggested by AI to include in this deck are displayed on the Editing tab 2120. Suggested slides 2105 can be further filtered by facets and content from Liked Slides or Lists. In addition, the user 1810 can enter search terms to find slides pertaining to a specific topic. The user 1810 can drag and drop the slides from the Suggested Slides 2105 to the Your Presentation pane 2110 to include them in the new presentation. The slide content in Your Presentation pane 2110 is parsed into snippets 2115. The user 1810 can select a template 2130 to use for the new presentation or opt to accept the default template. The user 1810 can enter a name for the new presentation and save the file 2125. This newly created presentation is displayed on the Homepage 2030, Presentation tab 2035, and Slides tab 2040. The user 1810 can view and download the deck to refine further using presentation software such as PowerPoint.

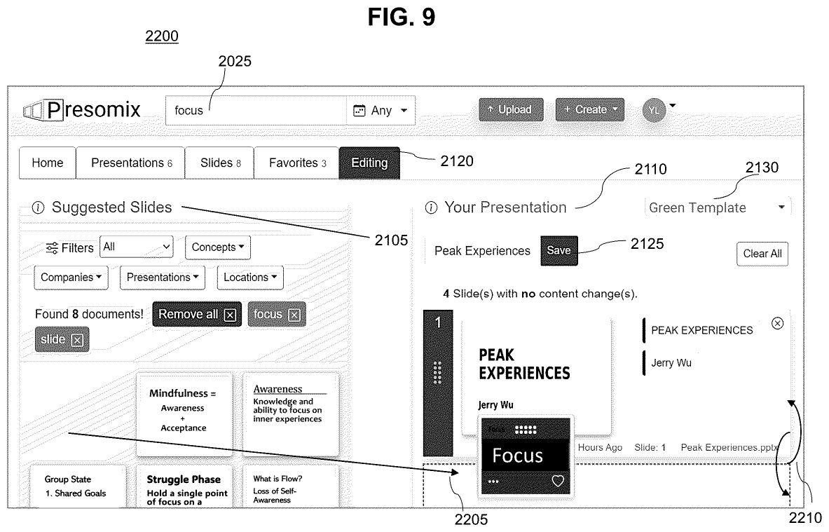

FIG. 9 is a diagram illustrating an embodiment of a graphical user interface (GUI) 2200 for enabling a user to dynamically edit and author a new presentation deck using AI-suggested and AI-generated slides, according to one implementation.

In this embodiment, GUI 2200 displays content when the user 1810 selects to create a new presentation. The user 1800 is presented with a blank pane for Your Presentation 2110 and recommended slides in the Suggested Slides pane 2105. The user 1810 informs the context of the new presentation by using the search feature 2025 in the Editing view 2120. The slides suggested by AI to include in this deck are displayed. The user 1800 can drag and drop the slides 2205 from the Suggested Slides to the Your Presentation pane to include them in the new presentation. The user 1810 can move the slides in the Your Presentation pane up and down to reorder the slide sequence 2210. For each slide, the user 1810 can view the text or image suggestions recommended by the system. The system uses an ensemble of deep learning techniques to generate human-readable text and/or image suggestions. The user 1810 can accept or further modify the slide content. The user 1810 can also request the system to auto-generate new slides based on the context provided by slides already added to the Your Presentation edit palette. To create a new presentation, the user 1810 can enter a name and save the file 2125. This newly created presentation is displayed on Homepage 2030, Presentation tab 2035, and Slides tab 2040. The user 1810 can view and download the deck to further refine using presentation software such as PowerPoint.

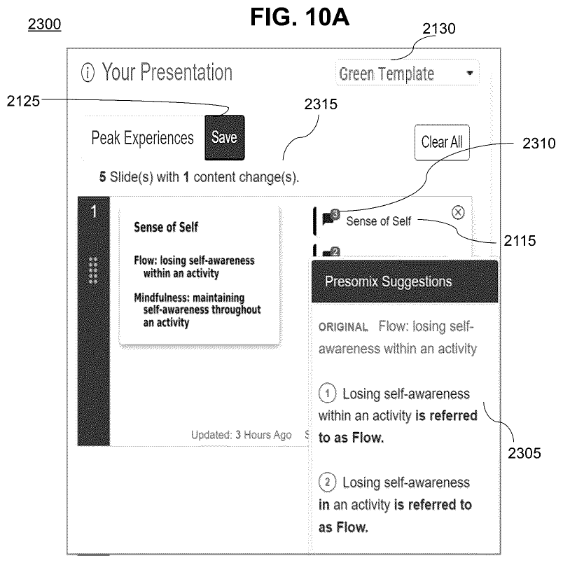

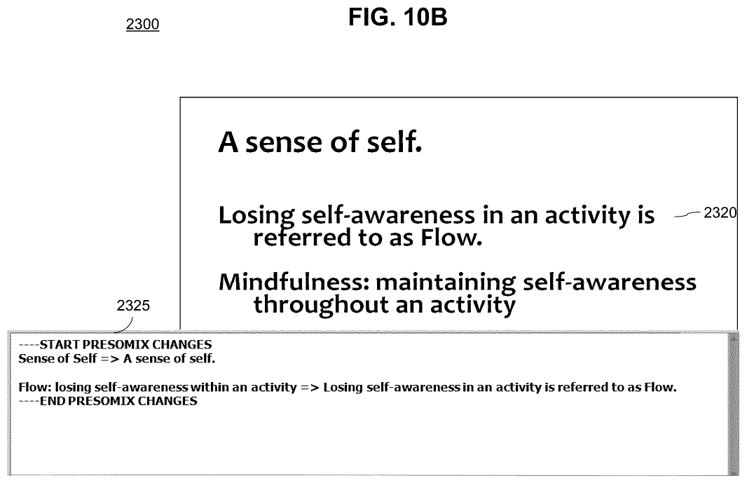

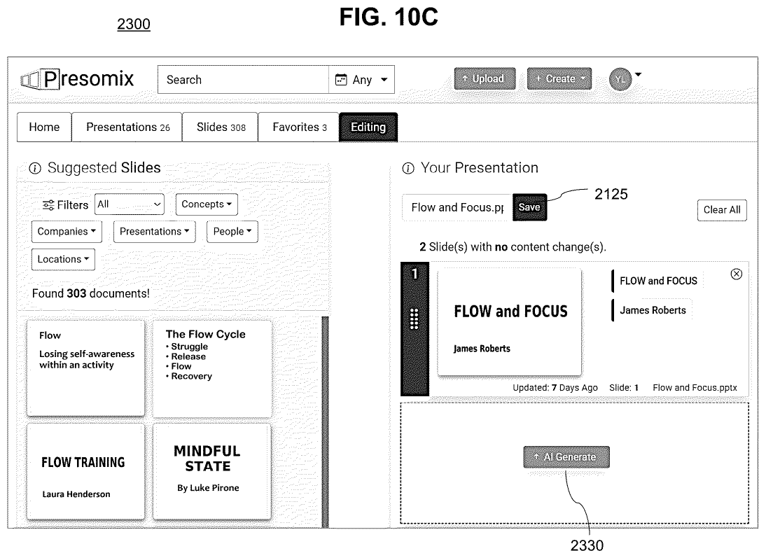

FIGS. 10A, 10B, and 10C are diagrams illustrating an embodiment of a GUI 2300 for enabling a user to auto-create a new slide with AI-generated content, according to one implementation.

In this embodiment, GUI 2300 displays content when the user 1810 selects AI-generated content to create a new slide. Text and/or image snippets 2115 for the slide are displayed next to the slide's thumbnail. The number of text or image suggestions 2310 is displayed on the left corner of each snippet to inform the user to check out AI recommendations. The system uses a combination of natural language processing, natural language generation, and machine learning to generate human-readable text suggestions and image recognition to display image suggestions. The user 1810 can view the text or image suggestions 2305 and select one of the options to accept the relevant recommendations. The user 1810 is informed of the number of content changes and the number of slides with updates 2315. The user 1810 can also choose to update the slide content with their own knowledge by directly editing the snippet 2115. The user 1810 can enter a name for the new slide and save the file 2125. This newly created slide is displayed on Homepage 2030, Presentation tab 2035, and Slides tab 2040.

The user 1810 can view and download the slide to further refine using presentation software such as PowerPoint. From presentation software, the user 1810 can view the updated slide 2320 and the details of AI recommended changes incorporated in the slide 2325. The changes from original content to updated content are documented in the notes section of the new slide 2325.

Another way to auto-create a new slide with AI-generated content is by clicking on the AI Generate button 2330, which will use slides already added to the Your Presentation edit palette as context to compose a new presentation using Generative AI.

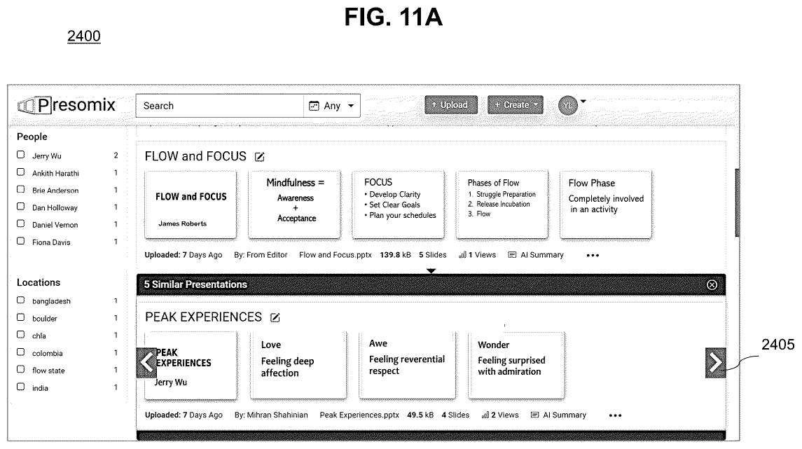

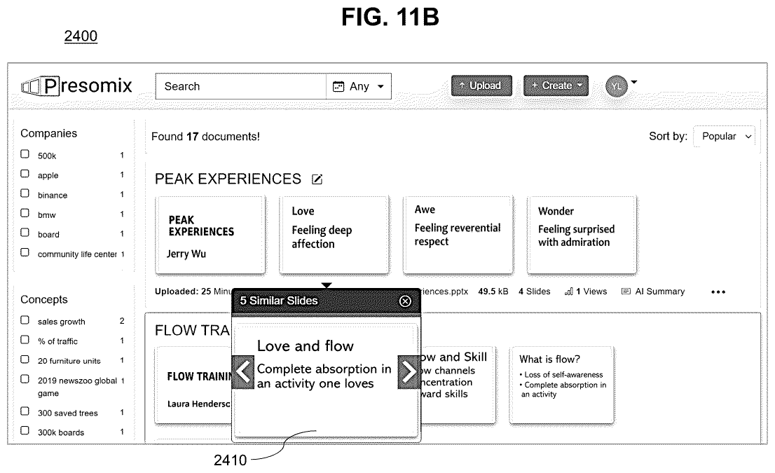

FIGS. 11A and 11B are diagrams illustrating an embodiment of a GUI 2400 for enabling a user to discover similar content, according to one implementation.

In this embodiment, GUI 2400 displays content processed by the AI Engine 1600 when the user 1810 requests to find similar content. This option shows a scrollable list of similar presentations 2405 (FIG. 11A) or similar slides 2410 (FIG. 11B). The system 1000 uses a combination of natural language processing and machine learning to classify content similar to the presentation or slide the user 1810 has selected. The similarity may be based on relevant content within a slide's text, charts, or metadata. In some cases, the similarity may include compilation or calculation from processed data from multiple slides to determine relevant context.

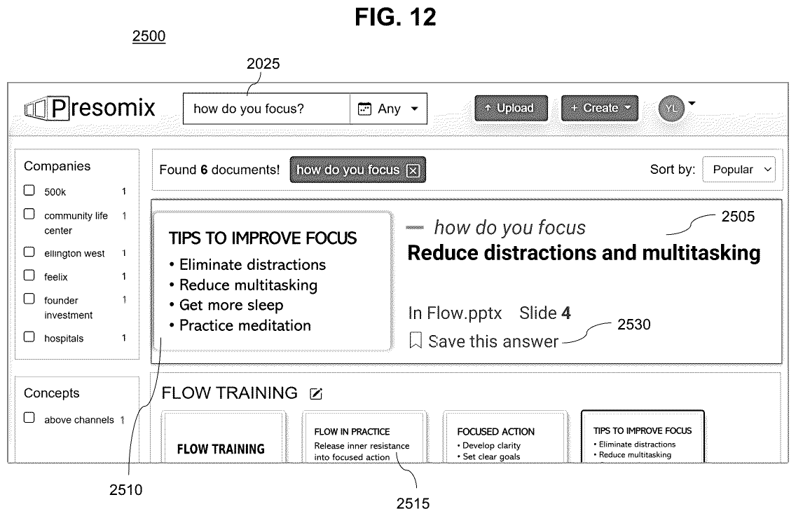

FIG. 12 is a diagram illustrating an embodiment of a GUI 2500 for enabling a user to ask questions and find answers and associated slides, according to one implementation.

In this embodiment, GUI 2500 displays content processed by the AI Engine 1600 when the user 1810 asks a question 2025. The system uses an ensemble of deep learning techniques and generative AI technology to generate human-readable answers 2505 and display them below the search bar along with associated slides 2510. Other slides with relevant content to the question are also displayed 2515. The user 1810 can save the answers 2530 they like, and these answers will appear in the Liked Answers list on the Favorites tab 2075. From the list of liked answers, the user 1810 can choose the liked answers to incorporate into an AI-generated slide and presentation from the Editing view 2120.

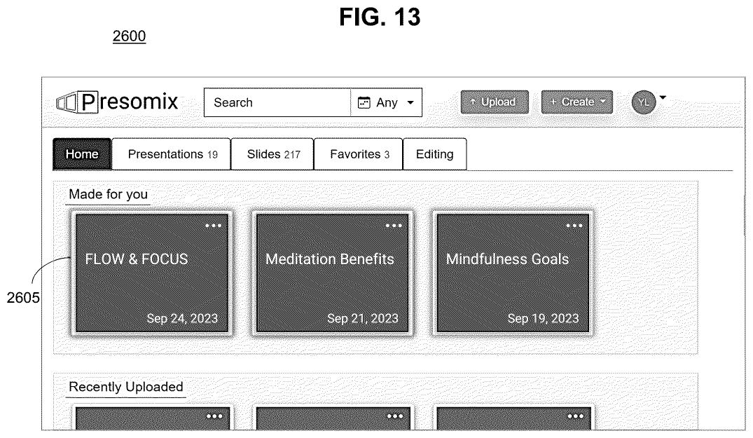

FIG. 13 is a diagram illustrating an example of a GUI 2600 for enabling a user to find the newly created presentation in the system, according to one embodiment.

In this embodiment, GUI 2600 displays the newly created presentation 2605 in the system. The user 1810 can download, view, modify, and save the newly created presentation using standard presentation software such as Microsoft PowerPoint. If the slides in the presentation were updated using the AI text or image suggestions 2305 or by the user 1810 directly editing the snippets, these modifications are reflected on the slide 2320. In addition, changes from original content to updated content are documented in the notes section of the newly created presentation 2325.

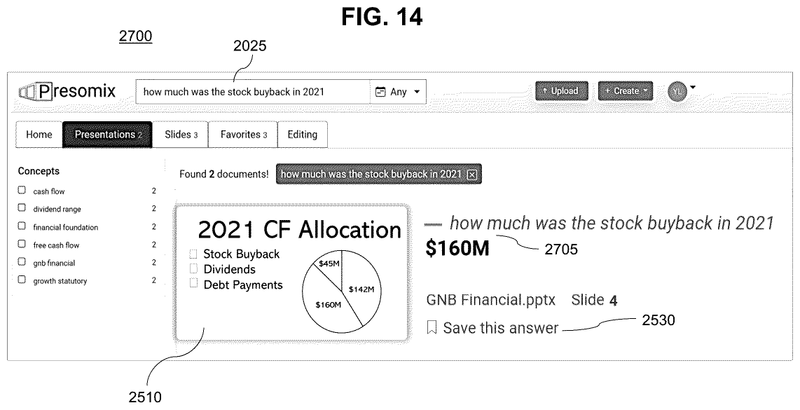

FIG. 14 is a diagram illustrating an embodiment of a GUI 2700 for enabling a user to ask questions and find answers located on charts and tables embedded in slides, according to one implementation.

In this embodiment, GUI 2700 displays content processed by the AI Engine 1600 from charts and tables when the user 1810 asks a question 2025. The system uses an ensemble of deep learning techniques, content parsing, and generative AI technology to generate human-readable answers from charts and tables 2705. The best answer 2705 is displayed below the search bar, while relevant slides 2510 are highlighted. The user 1810 can save the answers 2530 they like, and these answers will appear in the Liked Answers list on the Favorites tab 2075. From the list of liked answers, the user 1810 can choose the liked answers to incorporate into an AI-generated slide and presentation from the Editing view 2120.

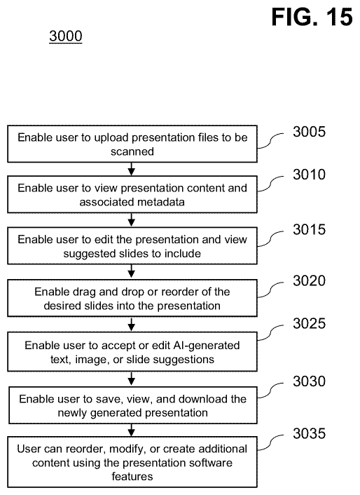

FIG. 15 is a flow diagram illustrating a method of an end-user device of an artificial intelligence assistant computing facility 1000 for enabling a user to create a new presentation deck from existing presentations, according to one embodiment.

In the flow illustrated by 3000, the method includes enabling the user 1810 to upload presentation files to be scanned, as indicated in block 3005. Alternatively, the user 1810 can select directories to be scanned or use previously selected directories. The artificial intelligence assistant computing facility extracts and processes content to show the user, as indicated in block 3010. In this embodiment, the method includes enabling the user 1810 to edit the deck to create a new presentation, and the system automatically suggests related slides, as indicated in block 3015. If the user 1810 sees slides they want to use, they can drag and drop them into the new presentation. As indicated in block 3020, the user 1810 can also drag and drop to sequence the slides in the desired order. For each slide in the new presentation, the system recommends text or images to modify the slide or auto-create a new slide to fit the new content and flow, as indicated in block 3025. The artificial intelligence assistant computing facility suggests text, images, or slides based on the skills learned by the AI Engine 1600 and from the input provided by the user 1810. The user 1810 can save, view, and download the new presentation, as indicated in block 3030. Once the presentation has been downloaded, the user 1810 can further tweak the content, as indicated in block 3035, using presentation software such as PowerPoint.

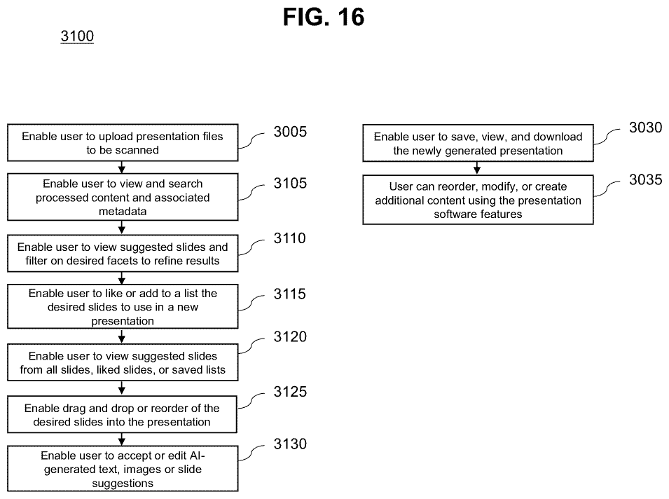

FIG. 16 is a flow diagram illustrating a method of an end-user device of an artificial intelligence assistant computing facility 1000 for enabling a user to create a new presentation deck from discovered content, according to one embodiment.

In the flow illustrated by 3100 in FIG. 16, the user 1810 can conduct a text search and view system-generated results, including slides associated with what the AI Engine 1600 classified to be relevant to the search terms, as indicated in block 3105. In some cases, the search may include slides having the search terms within the body of the slide or within any portion of the slide. In other cases, the search may include searching for slides based on a match of the search terms with the metadata associated with slides. Other embodiments may include a combination of these and/or other search techniques. The search results are displayed with an image of the content, as illustrated in FIGS. 7-14. The search results may be displayed in a carousel, card, list, or other display arrangements. As indicated in block 3110, the user 1810 can refine the results further by filtering on facets. As indicated in blocks 3115 and 3120, the method includes enabling the user 1810 to like slides or add them to a list and suggesting slides for a new deck from liked slides or saved lists as well as all slides. The user 1810 can use the drag and drop feature 3125, AI suggestions for text, images, or slides 3130, and save the new presentation 3030. The user 1810 can finalize the content using presentation software applications, as indicated in block 3035.

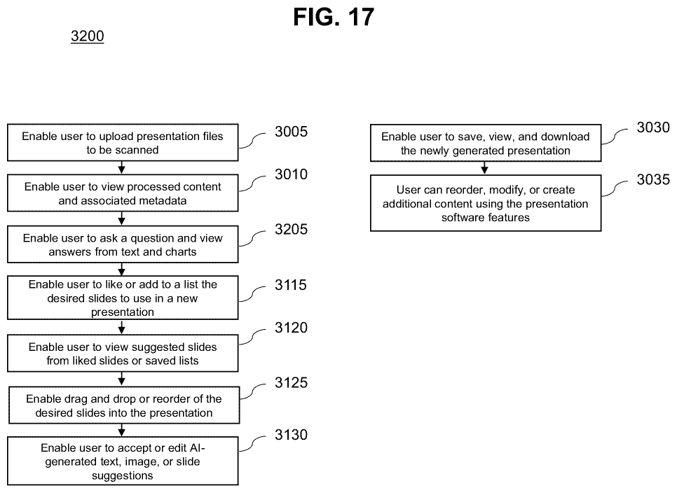

FIG. 17 is a flow diagram illustrating a method of an end-user device of an artificial intelligence assistant computing facility 1000 for enabling a user to create a new presentation from answers found in slide content, according to one embodiment.

As illustrated by 3200 in this embodiment, the user 1810 is enabled to ask a question via text search and view answers compiled from extracted and processed slides for the artificial intelligence assistant computing facility. The user 1810 can ask a question about the contents of charts via text search, as indicated in block 3205. The answers displayed may include slides associated with what the AI Engine 1600 classified to be relevant to the question. In some cases, the answer may consist of relevant content within a slide's text, charts, or metadata. In other cases, the answer may include compilation or calculation from processed data from multiple slides and/or presentations. Other embodiments may include a combination of these and/or other question and answer techniques. As indicated in block 3115, the user 1810 can like specific answers presented in the GUI or add the slide to a list. In this embodiment, the method includes enabling the user 1810 to view suggested slides from liked slides or saved lists 3120 and select from this list to create a new presentation containing answers to the user's questions. The artificial intelligence assistant computing facility suggests text, images or slides based on the skills learned by the AI Engine 1600 and from the input provided by the user 1810 in blocks 3205, 3115, and 3125. Once the new presentation deck has been saved and downloaded, the user 1810 can view and update the content using the presentation software features.

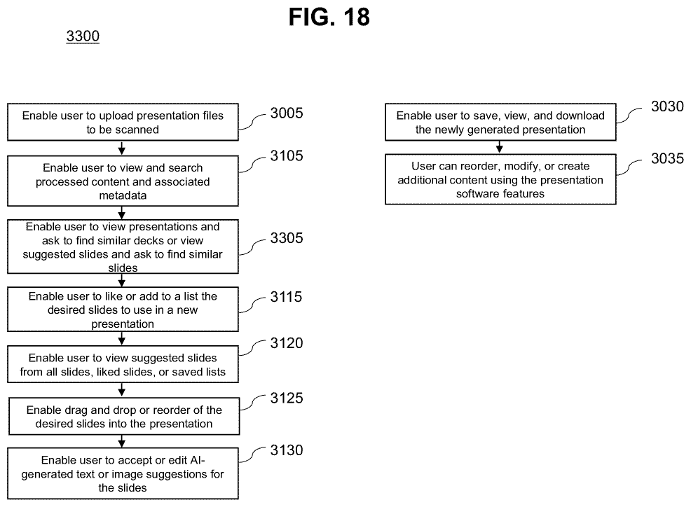

FIG. 18 is a flow diagram illustrating a method of an end-user device of an artificial intelligence assistant computing facility 1000 for enabling a user to find similar slides and presentations, according to one embodiment.

As illustrated by 3300 in this embodiment, the user 1810 is enabled to ask to find similar decks or slides from extracted and processed content, as indicated in block 3305. Similar presentations or slides may include content associated with what the AI Engine 1600 classified to be relevant to the presentation or slide the user has selected. In some cases, the similarity may be based on relevant content within a slide's text, charts, or metadata. In other cases, the similarity may include compilation or calculation from processed data from multiple slides. Other embodiments may include a combination of these and/or other similarity detection techniques. As indicated in block 3115, the user 1810 can like specific slides presented in the GUI or add them to a list. In this embodiment, the method includes enabling the user 1810 to view suggested slides from liked slides or saved lists and select from this list to create a new presentation. Once the new presentation deck has been saved and downloaded, the user 1810 can view and update the content using the presentation software features.

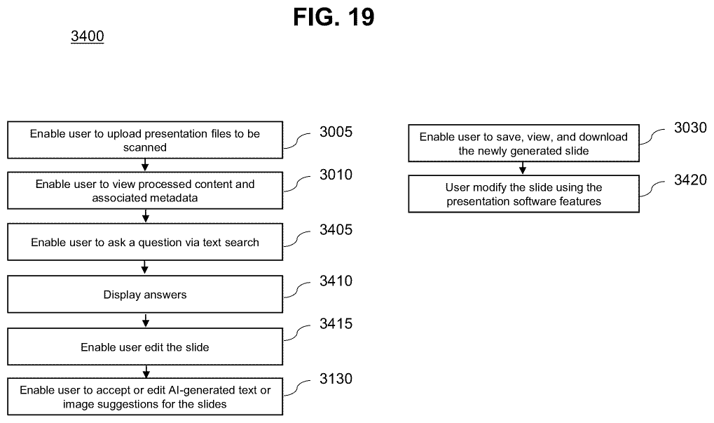

FIG. 19 is a flow diagram illustrating a method of an end-user device of an artificial intelligence assistant computing facility 1000 for enabling a user to find answers from slide content to create a new slide, according to one embodiment.

In the flow illustrated by 3400, the user 1810 is enabled to ask questions and create new content by using the AI-provided text or image suggestions to edit the slide with the answer. As indicated in blocks 3405 and 3410, the user 1810 can ask questions and view the answer and associated slide. The answers displayed, as indicated in block 3410, may include slides having content associated with what the AI Engine 1600 classified to be relevant to the question. In some cases, the answer may include slides having the relevant content within the slide or metadata associated with slides. In other cases, the answer may consist of compilation or calculation from processed data from multiple slides and/or presentations. Other embodiments may include a combination of these and/or other question and answer techniques. The user 1810 can edit the slide and manually update the content or use the system-provided suggestions for text and image updates, as indicated in blocks 3415 and 3130. The user 1810 can view and update the content using the presentation software features once the slide has been saved and downloaded.

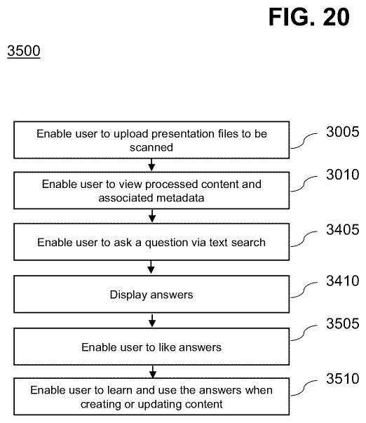

FIG. 20 is a flow diagram illustrating a method of an end-user device of an artificial intelligence assistant computing facility 1000 for enabling a user to discover answers in slide content to learn and increase knowledge, according to one embodiment.

As illustrated by 3500 in this embodiment, the user 1810 is enabled to ask a question via text search and view answers compiled from extracted and processed slides to discover new information. The method includes allowing the user 1810 to upload presentation files to be scanned, as indicated in block 3005. The content auto-generation and organization system 1000 extracts and processes content to show the user 1810. As indicated in block 3405, the user 1810 can ask a question via text search. The answers displayed, as indicated in block 3410, may include slides having content associated with what the AI Engine 1600 classified to be relevant to the question. In some cases, the answer may include slides having the relevant content within the slide or metadata associated with slides. In other cases, the answer may consist of compilation or calculation from processed data from multiple slides and/or presentations. Other embodiments may include a combination of these and/or other question and answer techniques. As indicated in block 3505, the user 1810 is enabled to like specific answers presented in the GUI. The user 1810 is enabled to discover new information, learn from answers offered, and use this knowledge when creating, updating, or presenting content, as indicated in block 3510.

B. Interpretable Organization of Presentation Library

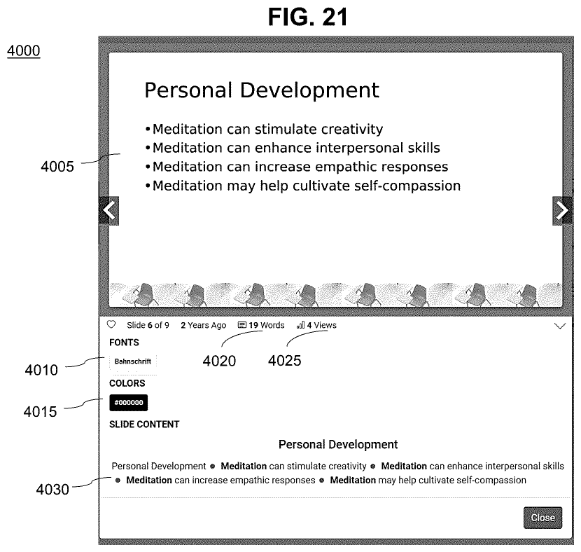

FIG. 21 is a diagram illustrating an example of a graphical user interface (“GUI”) for enabling a user to view extracted content from slides, according to one embodiment. In this embodiment, GUI 4000 displays slide details for content processed by the AI Engine 1600. For each slide, the user 1810 can see a large thumbnail of the original slide 4005, fonts 4010, colors 4015, word count 4020, number of views 4025, and the actual text 4030 used in the slide.

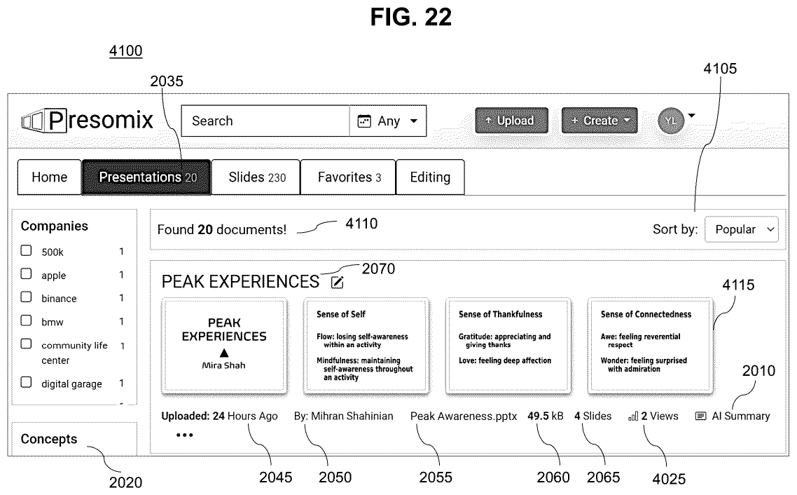

FIG. 22 is a diagram illustrating an example of a GUI for enabling a user to view organized and classified content from slides, according to one embodiment. In this embodiment, GUI 4100 displays content processed by the AI Engine 1600 sorted by popularity 4105 in the Presentation tab. The user 1810 can see the number of documents 4110 in the content library.

For each presentation deck, the user 1810 can see the presentation title 2070, representing the main theme of the content, uploaded date 2045, uploaded by 2050, file name 2055, file size 2060, the number of slides 2065, and the number of views 4025. The user 1810 can also see thumbnails of slides 4115 comprising the presentation. The presentation title 2070 is provided in addition to the file name to help the user easily find the theme or the context of the content in the presentation deck. The presentation title 2070 is determined by scanning the key slides and analyzing the text. The greatest weight is given to the largest, contiguous text with the highest contrast between the background and the text on the first slide. Relevant facets 2020 for the processed content are displayed on the left panel shown in FIG. 22.

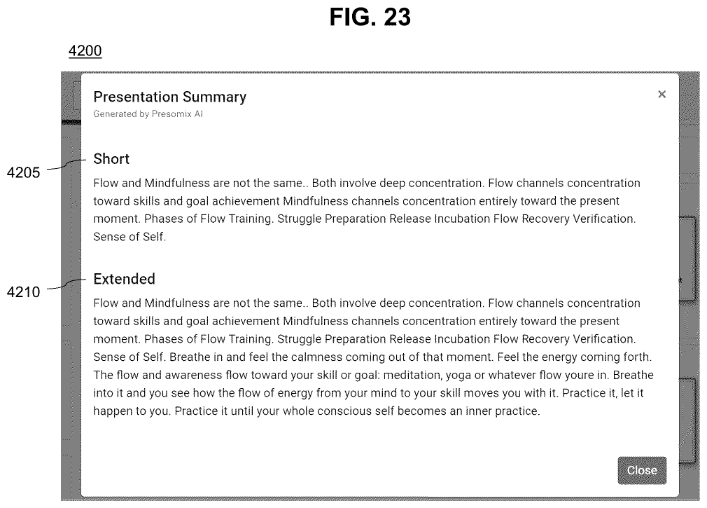

FIG. 23 is a diagram illustrating an example of a GUI for enabling a user to view summarized content from slides, according to one embodiment. In this embodiment, GUI 4200 displays an AI-generated summary for an abstract of the content generated through natural language processing and natural language generation. The short summary 4205 gives a quick synopsis of the content, while additional details are generated using text-to-text generation models for the extended summary 4210. AI-generated summaries are used to find similar presentations.

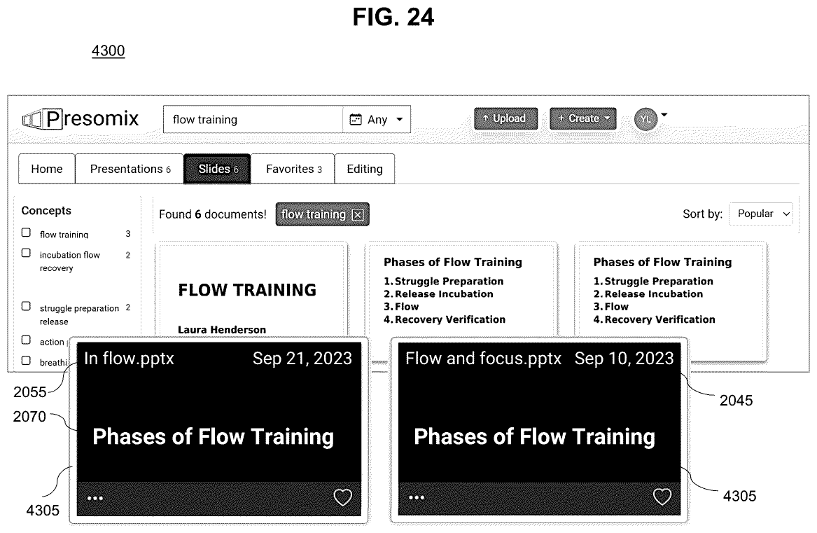

FIG. 24 is a diagram illustrating an example of a GUI for enabling a user to view multiple versions of a single instance of content from slides, according to one embodiment. In this embodiment, GUI 4300 displays the detection of multiple versions of a single instance of a slide. Multiple versions of the same slide can be detected using vector representations of text along with slide metadata. The user 1810 can view the same slide belonging to multiple presentations 4305 and their associated metadata such as presentation title 2070, uploaded date 2045, and file name 2055.

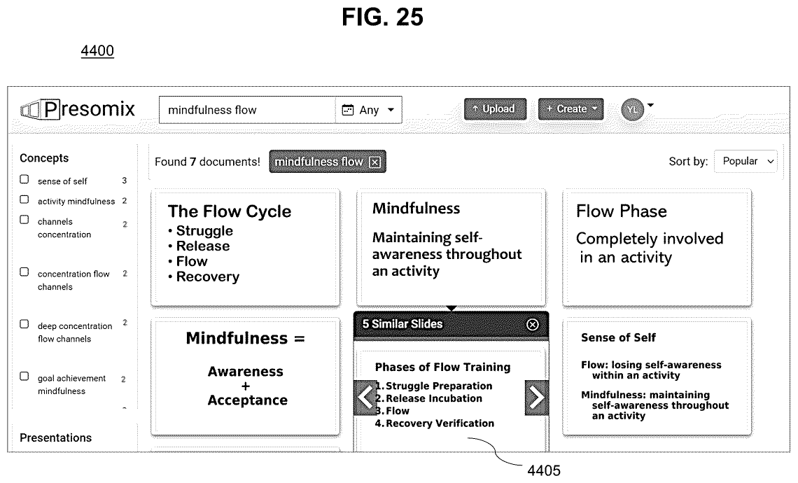

FIG. 25 is a diagram illustrating an example of a GUI for enabling a user to view similar slides or presentations according to one embodiment. In this embodiment, GUI 4400 displays content processed by the AI Engine 1600 when the user 1810 requests to find similar content. This option shows a scrollable list of similar slides 4405. The system uses a combination of natural language processing and machine learning to classify content similar to the slide the user has selected. The similarity may be based on relevant content within a slide's text, charts, or metadata. The user 1810 can also view similar presentations as classified by natural language processing and machine learning. In addition to the similarity detection based on specific slide content, the context of the slide or relevancy of the content in a presentation determined by a compilation or calculation from processed data from multiple slides may be used to detect slide or presentation similarity.

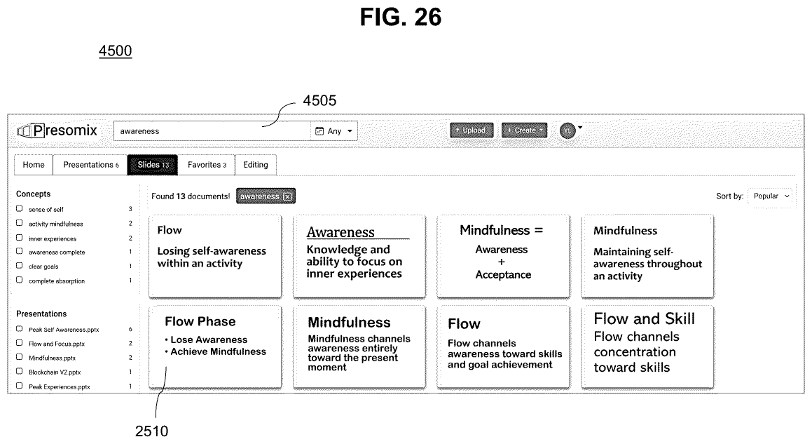

FIG. 26 is a diagram illustrating an example of a GUI for enabling a user to find slide content matching the search query, according to one embodiment. In this embodiment, GUI 4500 includes a text window with the search button 4505. The user 1810 can enter a search query in the search box 4505 to find relevant content and the slides that match the query 2510 are highlighted. The user 1810 can find slides relevant to the search terms or answers to questions posed using the search box 4505.

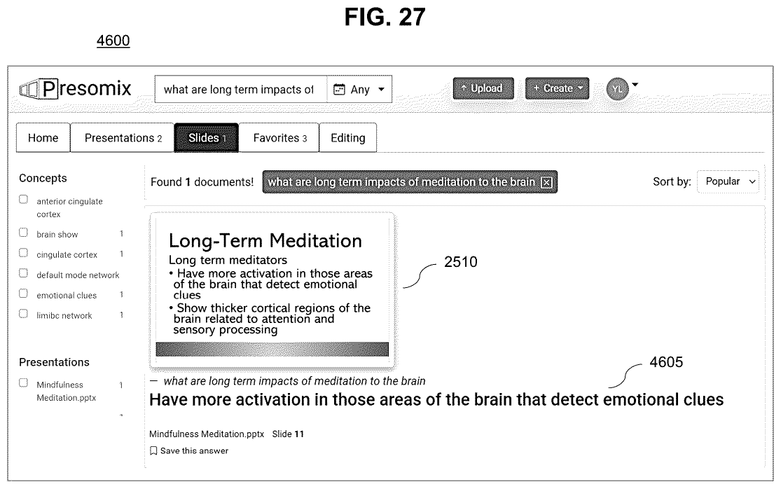

FIG. 27 is a diagram illustrating an example of a GUI for enabling a user to find the most relevant slide and the best sentence matching the search query, according to one embodiment. In this embodiment, GUI 4600 displays the most relevant slide 2510 based on the content processed by the AI Engine 1600 for a user's search query. The system uses an ensemble of deep learning techniques to find the best sentence matching the user's query 4605 and display it below the search bar.

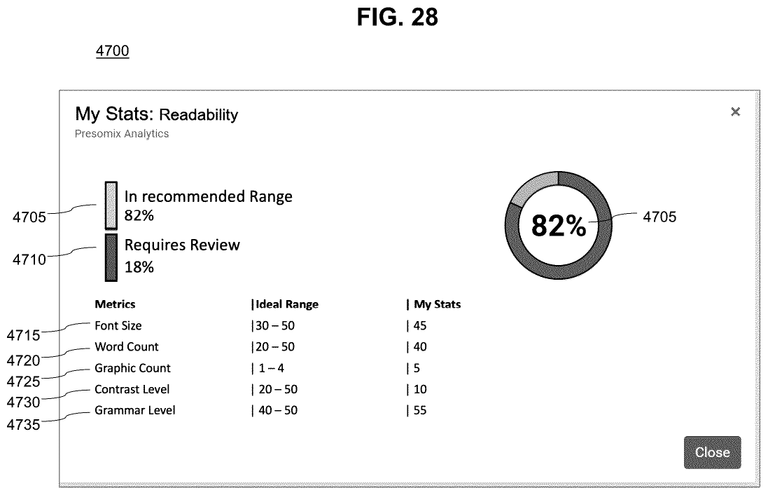

FIG. 28 is a diagram illustrating an example of a GUI for enabling a user to view statistics on the readability of each slide, according to one embodiment. In this embodiment, GUI 4700 displays the readability statistics for the user's slide in the content library. The user 1810 can view the readability score as defined as a percentage that is in the ideal range 4705. The user 1810 can easily view how their values compare against the ideal range for font size 4715, number of words 4720, number of graphics 4725, contrast level 4730, and grammar level 4735.

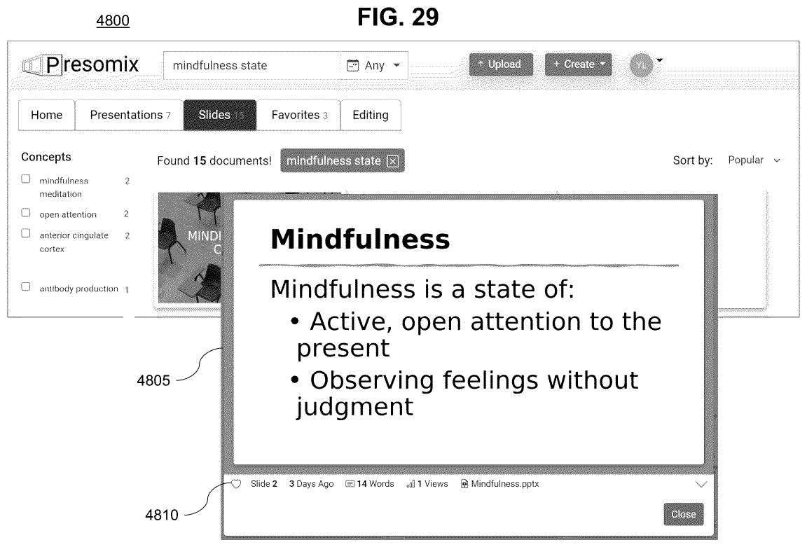

FIG. 29 is a diagram illustrating an example of a GUI for enabling a user to view a collection of slides and individual slide details, according to one embodiment. In this embodiment, GUI 4800 displays a collection of slides in the content library. The user 1810 can view collections of slides matching a search query, specific filter, or comprising a presentation. Clicking on a particular slide will zoom in so the user 1810 can read the content details 4805. The user 1810 can take actions on a specific slide, such as clicking on the heart icon 4810 to like the slide.

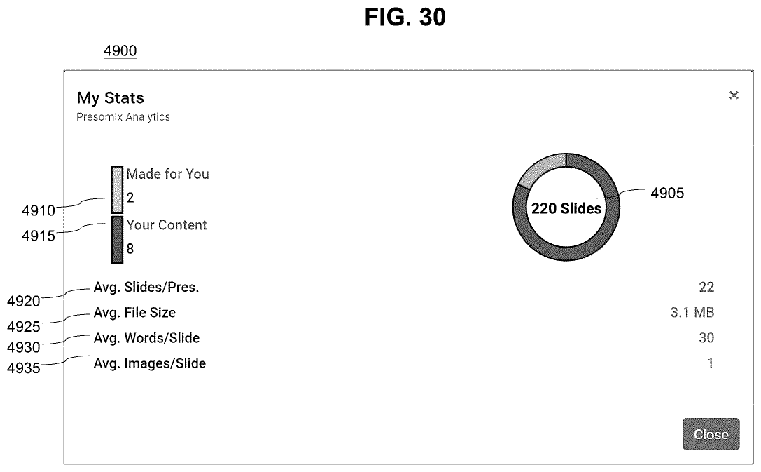

FIG. 30 is a diagram illustrating an example of a GUI for enabling a user to view statistics on content library artifacts, according to one embodiment. In this embodiment, GUI 4900 displays key statistics about the content in the content library. The user 1810 can view the total number of slides 4905, the number of presentations uploaded 4915, and the number of presentations auto generated by the system 4910. In addition, the user 1810 can easily view the average metrics for the number of slides in a presentation 4920, file size 4925, words in a slide 4930, and images in a slide 4935.

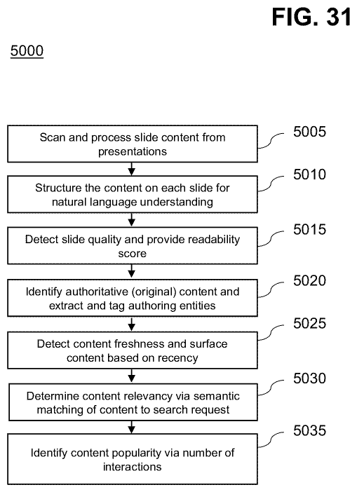

FIG. 31 is a flow diagram illustrating a method of an end-user device of an artificial intelligence assistant computing facility 1000 for surfacing documents by combining the quality (readability), authority (authoring), freshness (recency), relevancy (semantic matching), popularity (number of clicks) of each slide in the content library, according to one embodiment. In the flow illustrated by 5000, the user 1810 can conduct a text search and view system-generated results for slide content scanned and processed from presentations, as indicated in block 5005. The content on each slide is structured using natural language understanding, as indicated in block 5010, and scored for quality and readability, as indicated in block 5015. The methods to identify authoritative content and extract and tag authoring entities, as indicated in block 5020, further organizes the content and tracks the relationship among the slides in the content library. The user 1810 can refine the results based on recency, relevancy, or popularity. As indicated in block 5025, the method to detect content freshness allows the user to view the content based on recency. Using semantic matching of content to search requests, as indicated in block 5030, content relevancy can be determined. As indicated in block 5035, the method to identify content popularity by tracking the number of interactions enables the user 1810 to sort the content based on popularity.

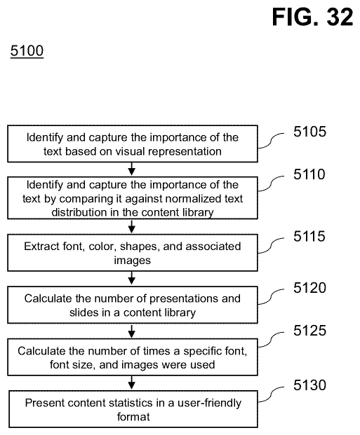

FIG. 32 is a flow diagram illustrating a method of an end-user device of an artificial intelligence assistant computing facility 1000 for presenting a user with key metrics about slide content in the content library, according to one embodiment. In the flow illustrated by 5100, the user 1810 can view useful statistics to help organize, find, reuse, and edit content in the content library. As indicated in blocks 5105 and 5110, the system identifies and captures the importance of the text based on visual representation on a slide and compares it against normalized text distribution in the content library. The method to extract font, color, shapes, and associated images, as indicated in block 5115, allows the user 1810 to view this information and apply them in slide creation or edits. The system calculates the number of presentations and slides in a content library, as indicated in block 5120, and calculates the number of times a specific font, font size, and images were used, as indicated in block 5125. The system presents these metrics in a user-friendly format, as indicated in block 5130, to facilitate applying this insight to slide reuse and creation.

It should be understood that the steps, processes, or operations described herein may represent any module or code sequence that can be implemented in software or firmware. In this regard, these modules and code sequences can include commands or instructions for executing specific logical steps, processes, or operations within physical components. It should further be understood that one or more of the steps, processes, and/or operations described herein may be executed substantially simultaneously or in a different order than explicitly described, as would be understood by one of ordinary skill in the art.

The embodiments described herein represent a number of implementations and examples and are not intended to necessarily limit the present disclosure to any specific embodiments. Instead, various modifications can be made to these embodiments as would be understood by one of ordinary skill in the art. Any such modifications are intended to be included within the spirit and scope of the present disclosure and protected by the following claims.

We claim:

1. A method of electronic presentation assistance, the method comprising:
receiving, via an artificial intelligence assistant computing facility or a component or a module thereof, one or more presentations made available by a first user, the one or more presentations comprising slides;
receiving, via the artificial intelligence assistant computing facility or the component or the module thereof, a request from a second user to generate specific content from information extracted from the one or more presentations;
analyzing, via the artificial intelligence assistant computing facility or the component or the module thereof, the one or more presentations to classify data and metadata for the slides;
generating, via the artificial intelligence assistant computing facility or the component or the module thereof, a summary for each of the one or more presentations;
determining, via the artificial intelligence assistant computing facility or the component or the module thereof, similarities in content;
determining, via the artificial intelligence assistant computing facility or the component or the module thereof and based on the second user request, a response to the second user request;
predicting content edits based at least in part on the second user requests and reaction to suggestions made via the artificial intelligence assistant computing facility or the component or the module thereof,
generating a compositional change to a slide in a presentation by the second user, via the artificial intelligence assistant computing facility or the component or the module thereof and based at least in part on the second user request, presentation context, and predicted reaction; and
generating a compositional change to the presentation by the second user, via the artificial intelligence assistant computing facility or the component or the module thereof and based at least in part on the second user request, presentation context, and predicted reaction.

2. The method of claim 1, further comprising:
assessing, via the artificial intelligence assistant computing facility or the component or the module thereof, the meaning of each slide in the one or more presentations;
determining, via the artificial intelligence assistant computing facility or the component or the module thereof, font, color, shapes and/or images from each slide in the one or more presentations; and
identifying, via the artificial intelligence assistant computing facility or the component or the module thereof, text and images from slides, charts, and/or graphs.

3. The method of claim 1, further comprising:
classifying, via the artificial intelligence assistant computing facility or the component or the module thereof, the content from each slide in the one or more presentations; and
determining, via the artificial intelligence assistant computing facility or the component or the module thereof, relevant topical categories and sub-categories for each slide in the one or more presentations.

4. The method of claim 1, further comprising:
summarizing, via an artificial intelligence assistant computing facility, the presentation;
wherein generating, via the artificial intelligence assistant computing facility or the component or the module thereof, a summary of presentation content for each of the one or more presentations.

5. The method of claim 1, further comprising:
determining, via the artificial intelligence assistant computing facility or the component or the module thereof, similarities between content of the one or more presentations, wherein the similarities between content of the one or more presentations are identified using vector representation of text and the slide metadata.

6. The method of claim 1, further comprising:
identifying, via the artificial intelligence assistant computing facility or the component or the module thereof, answers to questions posed by the second user wherein the artificial intelligence assistant computing facility or the component or the module thereof determines a best answer using a search lookup to generate a set of best possible answers and then uses deep learning to analyze and extract the best answer from candidate document results generated by the search lookup.

7. The method of claim 1, further comprising:
predicting, via the artificial intelligence assistant computing facility or the component or the module thereof, a set of slides and a slide sequence for a presentation in response to the second user request wherein the artificial intelligence assistant computing facility or the component or the module thereof, predicts the set of slides and the slide sequence based on topic similarity, usage frequency, presentation metadata similarity, and desired presentation length.

8. The method of claim 1, further comprising:
predicting, via the artificial intelligence assistant computing facility or the component or the module thereof, a content edit in a slide using machine learning technology.

9. The method of claim 1, further comprising:
composing, via the artificial intelligence assistant computing facility or the component or the module thereof, a new slide based on a context data of an existing slide.

10. The method of claim 1, further comprising:
generating, via the artificial intelligence assistant computing facility or the component or the module thereof, a new presentation;
wherein the new presentation where the presentation comprises an initial slide selected by the second user and a slide created by the artificial intelligence assistant computing facility or the component or the module thereof with inherited style and layout properties from the initial slide.

11. A computer readable medium containing software capable of performing the method according to claim 1.

12. A system for electronic presentation assistance, the system comprising;
an artificial intelligence assistant computing facility including:
at least one processor; and
a memory device storing software configured to cause the at least one processor to:
receive one or more presentations comprising a slide made available by a first user;
receive a request from a second user to generate specific content from information extracted from the one or more presentations;
analyze the one or more presentations to classify data and metadata for each slide of the one or more presentations;
generate a summary for each of the one or more presentations;
determine content similarities between the one or more presentations;
predict a content edit based at least in part on the second user request and a reaction to suggestions by the second user;
generate a compositional change to a slide constructed to respond to the second user request based at least in part on a presentation context and a predicted reaction; and
generate a compositional change to a presentation constructed to respond to the second user request based at least in part on a presentation context and a predicted reaction.

13. The system of claim 12, wherein the processor assesses the meaning of the content from each slide of the one or more presentations by determining font, color, shapes, images from each slide as well as text and images from slides, charts, and graphs; and classifies the content from each slide of the one or more presentations by determining relevant topical categories and sub-categories for each slide.

14. The system of claim 12, wherein the memory device is further configured to generate a summary of content for each of the one or more presentations.

15. The system of claim 12, wherein the processor is further adapted to determine similar content by identifying the similarity of each slide in the one or more presentations using vector representation of text and slide metadata and to identify the similarity of each presentation using vector representation of text, presentation summary, and presentation metadata.

16. The system of claim 12, wherein the processor predicts content edits in a slide, a slide for inclusion, and a slide sequence in a presentation.

17. The system of claim 12, wherein the at least one processor and a memory device storing an artificial intelligence assistant computing facility are configured to compose new slides through application of machine learning and generative AI technology based on context provided by slides already added to a presentation by the second user.

18. The system of claim 12, wherein the processor is further configured to generate a new presentation comprising a slide created using generative AI technology with inherited style and layout properties from an initial slide selected by the second user.

19. A system for electronic presentation assistance, the system comprising;
an artificial intelligence assistant computing facility including:
at least one processor; and
a memory device configured to adapt the at least one processor to:
receive one or more presentations made available by a first user;
receive a request from a second user to answer a specific question from information extracted from the one or more presentations;
analyze the one or more presentations to classify data and metadata for each slide of the one or more presentations;
generate a summary for each of the one or more presentations; and
generate from information extracted from the one or more presentations a human-readable answer to the specific question posed by the second user.

20. The system of claim 19, wherein the human-readable answer to the question posed by the second user are generated by assessing the meaning of each slide, classifying the content from each slide, summarizing the presentation, and generating a best possible answer;
to assess the meaning of each slide, the at least one processor and a memory device storing an artificial intelligence assistant computing facility is configured to determine font, color, shapes, images from each slide as well as text and images from slides, charts, and graphs;
to classify the content from each slide, the at least one processor and a memory device storing an artificial intelligence assistant computing facility is configured to determine relevant topical categories and sub-categories for each slide;
to summarize the presentation, the at least one processor and a memory device storing an artificial intelligence assistant computing facility is configured to generate a summary of the presentation content; and
to generate the human-readable answer, the at least one processor is configured to use a search lookup to identify a set of possible answers, use deep learning to analyze and extract a best possible answer from the set of possible answers, and use generative AI technology to compose the human-readable answer to the question posed by the second user.
